(19) United States
(12) Patent Application Publication
(10) Pub. No.: US 2026/0289154 A1
(43) Pub. Date: Sep. 24, 2026

(54) Resource-Efficient Interaction with a Multi-Modal Automated Agent

(71) Applicant: Microsoft Technology Licensing, LLC, Redmond, WA (US)

(72) Inventors: Jayant SHEKHAR, Hyderabad (IN); Aman Kumar PANDEY, Hyderabad (IN); Sandra ANIL, Hyderabad (IN); Aman JHA, Hyderabad (IN); Garima BEDI, Hyderabad (IN); Harsh SHARMA, Hyderabad (IN); Khushboo BINDAL, Hyderabad (IN); . DIVYANGANA, Hyderabad (IN)

(73) Assignee: Microsoft Technology Licensing, LLC, Redmond, WA (US)

(21) Appl. No.: 19/232,898

(22) Filed: Jun. 10, 2025

(30) Foreign Application Priority Data
Mar. 21, 2025 (IN) 202511026188
Apr. 25, 2025 (IN) 202511040300

(51) Int. Cl. G06F 40/40; G06F 3/0481; G06F 3/0485

(52) U.S. Cl. CPC G06F 40/40; G06F 3/0481; G06F 3/0485

(57) ABSTRACT

A client system interacts with a multi-modal automated agent via an agent interface in an efficient manner. The client system captures instance of image data from a camera or user-interface (UI) system at a prescribed image-capturing rate while a question is being asked. The client system sends the captured instances of query data and accompanying instances of query data to the automated agent via the agent interface in a series of content-bearing messages, and, in return, receives one or more replies from the automated agent via the agent interface. Other system features provide for the reduction in resolution of the instances of image data by the client system, the selective forwarding of only updated parts of the instances of image data that to the agent interface, and the static or dynamic insertion of prompt information into a system prompt by the agent interface.

### BACKGROUND

A client system, such as a smartphone, may execute an application that interacts with an automated agent through the exchange of text-based or spoken messages. This manner of interaction is inefficient in those circumstances in which a query cannot be quickly conveyed in verbal form.

### SUMMARY

A technique is described by which a client system (e.g., a smartphone) interacts with a multi-modal automated agent via an agent interface in an efficient manner. The client system captures instances of image data at a prescribed image-capturing rate while a question is being asked. The client system ceases capturing the instances of image data when the question ends. The client system sends the captured instances of image data and accompanying instances of query data (e.g., audio data or text-input data) to the automated agent via the agent interface in a series of content-bearing messages, and, in return, receives one or more replies from the automated agent via the agent interface.

In one mode, a captured instance of image data originates from a camera (e.g., from a camera buffer of the camera). For example, the client system captures image content from a front-facing camera and/or a back-facing camera of the client system.

In another mode, the client system samples an instance of screen image data that is being presented on a display device of the client. A user interface (UI) system generates the instance of screen image data and stores the screen image data in a screen buffer.

According to another illustrative aspect, the client system determines whether an instance of screen image data that is being displayed presents textual information. If so, the client system converts the instance of screen data to text, and then sends the text to the agent interface in lieu of the instance of screen image data.

According to another illustrative aspect, the client system provides no new screen image data to the agent interface upon concluding that a current instance of screen image data is unchanged relative to a previous instance of screen image data. In another case, the client system will provide a portion of the current instance of screen image data to the agent interface, less than an entirety of the current instance of screen image data, upon concluding, for example, that only that portion has changed. In other cases, the client system will provide an entirety of the current instance of screen image data to the agent interface.

According to another illustrative aspect, the client system applies one or more factors to determine a scope of screen image data to be sent to the agent interface. One scope of screen content is limited to application image data generated by a particular application.

According to another illustrative aspect, the client system reduces a resolution of each instance of image data it captures from a camera or UI system. For example, the client system reduces a resolution of an instance of image data to a fixed width and a height that depends on an aspect ratio of the display device of the client system. This is performed, for instance, by downscaling and/or compressing the image data. By reducing the resolution, the client system is able to reduce the amount of information that is transferred to the agent interface and the automated agent. Further, in some cases, by reducing the resolution of image data, the automated agent is able to expand the breadth of image content represented by its context window (compared to the case in which the image data is not reduced in resolution).

According to another illustrative aspect, the client system determines a rate-of-change measure that describes an extent to which image content is changing over a succession of captured instances of image data. In one mode, the client system dynamically sets the image-capturing rate based on a current rate-of-change measure.

According to another illustrative aspect, the agent interface inserts an instruction (“vision prompt”) pertaining to the processing of image content into a system prompt upon detecting that the client system has the capability of capturing instances of image data. In some implementations, this discovery occurs at application launch or other triggering event, and the vision prompt remains in place through use of the application whether or not the user is speaking or manipulating a text input device. In other implementations, the agent interface dynamically inserts the vision prompt at the start of the presentation of a query, and removes the vision prompt at the end of the query.

Overall, the above-described characteristics enable the client system to conduct a multi-modal interaction with the automated agent in an effective and resource-efficient manner without overwhelming the resources of either the client system or the automated agent. For instance, the technique reduces the amount of resources that are consumed in those periods in which the user is not speaking or manipulating a text input device. The targeted collection of image data also has the effect of more effectively focusing the automated agent on the user's query itself. Other features contribute to the resource efficiency of the technique, such as reducing the resolution of images by the client system and reducing the transfer of redundant image data to the agent interface.

The above-summarized technology is capable of being manifested in various types of systems, devices, components, methods, computer-readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF DRAWINGS

FIG. 1 shows an example of the operation of a multi-modal agent system at a first instance of time while a question is being asked. A camera captures a first image of the environment at this time.

FIG. 2 shows the operation of the multi-modal agent system at a second, later, instance of time during the same spoken query started in FIG. 1. The camera captures a second image of the environment at this time.

FIG. 3 is an example of the operation of the multi-modal agent system in which successive instances of screen image data presented on a display device are captured during a spoken or typed query.

FIG. 4 illustrates different scopes of screen content that a client system is capable of capturing while a question is being asked.

FIG. 5 shows one implementation of the multi-modal agent system for producing the experiences shown in FIGS. 1-4. The multi-modal agent system includes a client system (e.g., a smart phone), an agent interface, and an automated agent.

FIG. 6 shows one manner of operation of the multi-modal agent system of FIG. 5 in a static prompt insertion mode.

FIG. 7 shows one manner of operation of the multi-modal agent system of FIG. 5 in a dynamic prompt insertion mode.

FIG. 8 shows additional information regarding operations performed by the multi-modal agent system in the dynamic prompt insertion mode of FIG. 7.

FIG. 9 shows a process performed by the client system of FIG. 5.

FIG. 10 shows a process for sampling image content within the process of FIG. 9.

FIG. 11 shows a process performed by the agent interface of FIG. 5.

FIG. 12 shows an example of the transfer of a portion of screen image data to the agent interface of FIG. 5.

FIG. 13 shows a process performed by the automated agent of FIG. 5.

FIG. 14 shows one implementation of the agent interface of FIG. 5.

FIG. 15 shows one implementation of the client system of FIG. 5.

FIG. 16 shows one implementation of the automated agent of FIG. 5.

FIG. 17 shows one implementation of a language model which is used in the automated agent of FIG. 16.

FIG. 18 shows a process that provides an overview of the operation of the client system of FIG. 5.

FIG. 19 shows a process that provides an overview of the operation of the agent interface of FIG. 5.

FIG. 20 shows an illustrative type of computing system that, in some implementations, is used to implement any aspect of the features shown in the foregoing drawings.

The same numbers are used throughout the disclosure and figures to reference like components and features.

### DETAILED DESCRIPTION

A multi-modal agent system is described herein by which a client system conducts a multi-modal query session with an automated agent. The automated agent uses a multi-modal language model. In many of the examples presented below, the client system interacts with the automated agent through speech input and captured images. But the same principles apply to other combinations of input modes. For example, the same functionality described below is applicable to the case in which the user poses a question in textual form by interacting with a text input device, while also capturing images of the environment.

The image data captured during the query originates from one or more sources. In some examples, the image data is camera image data that originates from a camera provided (or used) by the client system (e.g., from a camera buffer of the camera). Section A describes one such example in which the image data is camera image data. In other examples, the image data is screen image data that originates from a user interface (UI) system (e.g., a screen buffer of the UI system) provided by the client system. The client system presents information on a display device of the client system based on the screen image data. Section B describes one such example in which the image data is screen image data. Other examples receive image data from yet other sources, including any of a video camera, a depth-sensing device, etc. Note that a viewfinder application (or other type of application) may display images currently being captured by a camera. In some implementations, the multi-modal agent system is configured to receive images directly from the camera buffer when the user is actively capturing images of the environment. However, other implementations may use other configurations.

In some implementations, the client system samples image data from either a camera (or cameras) and/or the UI system based on a mode setting. Alternatively, or in addition, the client system samples image data from whatever source(s) with which the user is interacting at the time of posing a question. For instance, if the user is interacting with a camera at the time of the question, the client system will sample from the camera. If the user is interacting with the user interface presentation provided by the display device of the computing system, then the client system samples image data from the UI system.

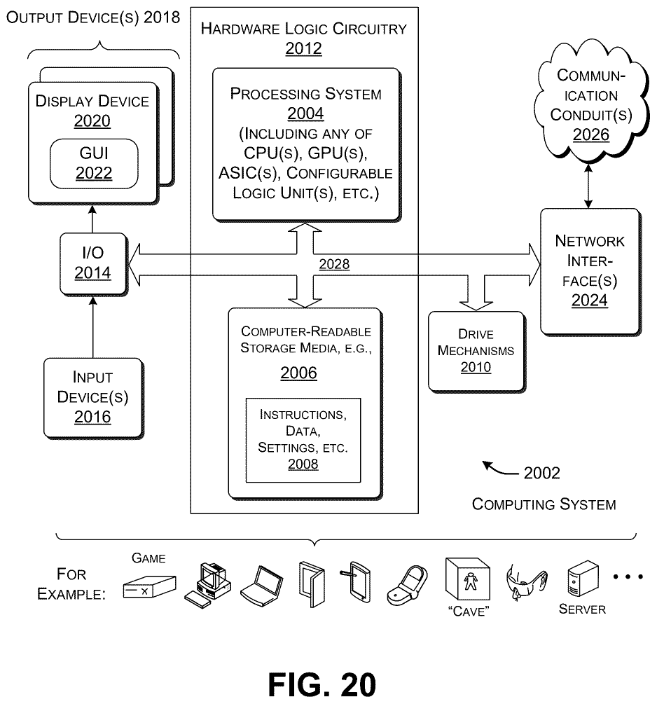

The following terminology is relevant to some examples presented below. On many occasions, an instance of image data is referred to as “image data” or just an “image” to simplify the explanation; all of these terms should be interpreted as referencing an item of image content. In some examples, a “machine-trained model” or “model” refers to computer-implemented logic for executing a task using machine-trained weights that are produced in a training operation. In some examples, a “language model” is a kind of machine-trained model that has been trained, at least in part, to predict a next word given a sequence of prior words. In some examples, a “parameter” refers to any type of parameter value that is iteratively produced by the training operation, such as a filter weight or bias value. In some examples, a “token” refers to a unit of information processed by a machine-trained model, such as a word or a part of a word. In some cases, a tokenizer produces the tokens, but an item (e.g., a text passage) is said to be composed of tokens in a general sense (in which “token” is a synonym of “part”), irrespective of when and where those tokens are actually produced. In some examples, a “prompt” refers to a sequence of tokens submitted to a machine-trained model. In some examples, a “system prompt” is a portion of the prompt that provides general instructions about how a language model is expected to interpret input information and formulate its reply. In some contexts, terms such as “component,” “module,” “engine,” and “tool” refer to parts of computer-based technology that perform respective functions. FIG. 20, described below, provides examples of illustrative computing equipment for performing these functions.

### A. Example in which Image Data Originates from a Camera

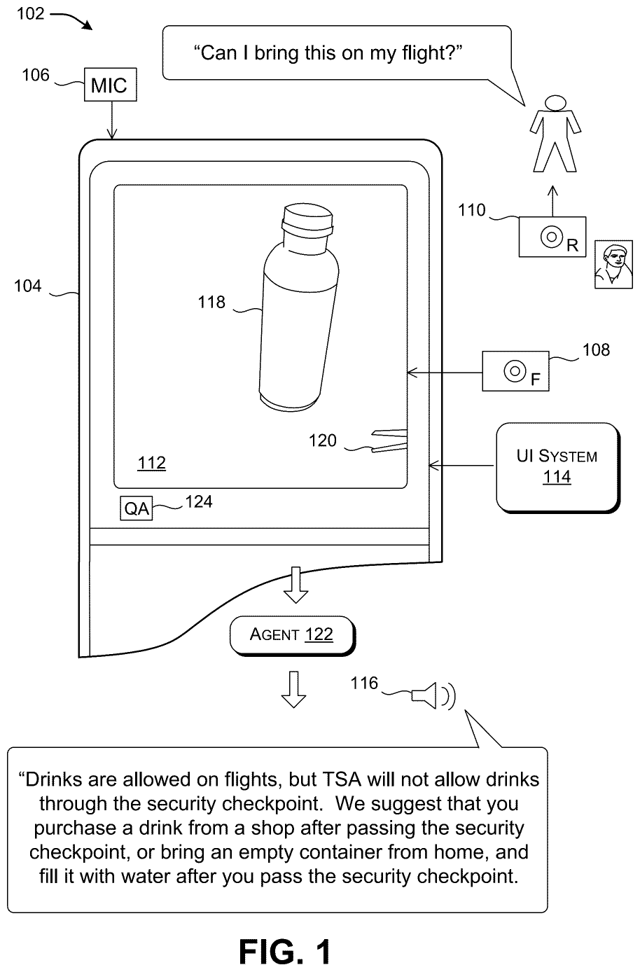

FIG. 1 shows the operation of a multi-modal agent system at a first instance of time 102 during a spoken query. A user interacts with the multi-modal agent system using a client system 104, such as a smartphone. In other examples, the client system 104 is a laptop computing device, a tablet computing device, a media device, any type of extended reality device, a wearable computing device, a standalone camera, and so on.

The client system 104 includes one or more microphones 106 for receiving audio signals from the environment in which the client system 104 operates, and one or more cameras for capturing visual content in the environment. More specifically, the cameras include at least one front-facing camera 108, each having a field-of-view (FOV) pointing outward and away from a user who operates the client system 104. The cameras also include at least one back-facing camera 110 having a FOV directed toward the user, e.g., which captures the face of the user. The client system 104 includes a display device 112 (e.g., a display screen) for displaying information based on screen image data generated by a user interface (UI) system 114. The client system 104 also includes one or more speakers 116 for presenting information in audible form. Alternatively, or in addition, the client system 104 may present the reply in textual form, e.g., on the display device 112 and/or in a separate message.

In the particular use case scenario shown in FIG. 1, in the first instance of time, the user points the client system 104 at a full beverage while simultaneously speaking the query “Can I bring this on my flight?” The intent of the user is to solicit advice on whether it is permissible to carry a full beverage container onto a flight. The display device 112 shows, via a viewfinder application, a preview of a camera image that is currently being captured by a camera. The camera image includes first content 118 that represents the beverage and second content 120 that shows the tip of a pair of scissors that rests on a table to the right of the beverage. An automated agent 122 replies by stating the circumstance in which a user typically may bring a full beverage onto a flight. The client system 104 presents the reply in audible form through its speaker(s) 116. At this time, the automated agent 122 has not yet recognized the scissors to the right of the beverage, and therefore provides no commentary on the scissors. In other implementations, the automated agent 122 recognizes that there is some object to the right of the beverage, and advises the user to provide another camera image that more clearly shows the scissors. The automated agent 122 provides the same recommendation if a representation in a camera image is too small to classify it. In this case, the automated agent 122 would ask the user to zoom in when taking a next camera image of the object in question.

More specifically, the client system 104 detects when the user begins to speak the message “Can I bring this on my flight?” This marks the start of a question. During the span of time that the question is being asked, the client system 104 instructs the camera(s) (108, 110) to capture images of the environment at a prescribed image-capturing rate. One or more configurable settings govern when any spoken query is considered to have ended. For example, a configurable permitted-silence threshold defines the maximum length of a pause that is acceptable before triggering an end-of-query determination.

In a fixed image capture mode, the client system 104 captures a still camera image every x seconds, where x is specified by the agent interface in an application setup process. In a dynamic image capture mode, the client system 104 measures the rate of range of camera image content over successive camera images that it has captured, as expressed by a rate-of-change measure. The client system 104 dynamically sets the camera image-capturing rate as a function of the rate-of-change measure, e.g., by increasing the image-capturing rate when the rate-of-change measure increases and decreasing the image-capturing rate when the rate-of-change decreases. In both modes, if the user continues to point the client system 104 at the beverage while asking a relatively long and detailed question about the beverage, the client system 104 potentially captures plural camera images showing the beverage, possibly at different visual perspectives (e.g., as a result of the user walking around the beverage while talking about it and pointing the client system 104 at it). In some implementations, the operation of capturing an image from a camera, in either the fixed or dynamic modes, is performed by sampling a camera image from a camera buffer of a camera. In other implementations, the operation of capturing an image is performed by instructing the camera to produce image data, which is then stored in the camera buffer. In either case, the camera system itself is the source of the camera image.

In some implementations, the client system 104 presents an icon 124 on the display screen 112. Activation of this icon 124 causes the client system 104 to invoke the application that performs the above-described agent-querying operations. Activation of this icon 124 again causes the client system 104 to close the application. At those times in which the application is not invoked, audio data and image data will not be captured and sent to the automated agent 122.

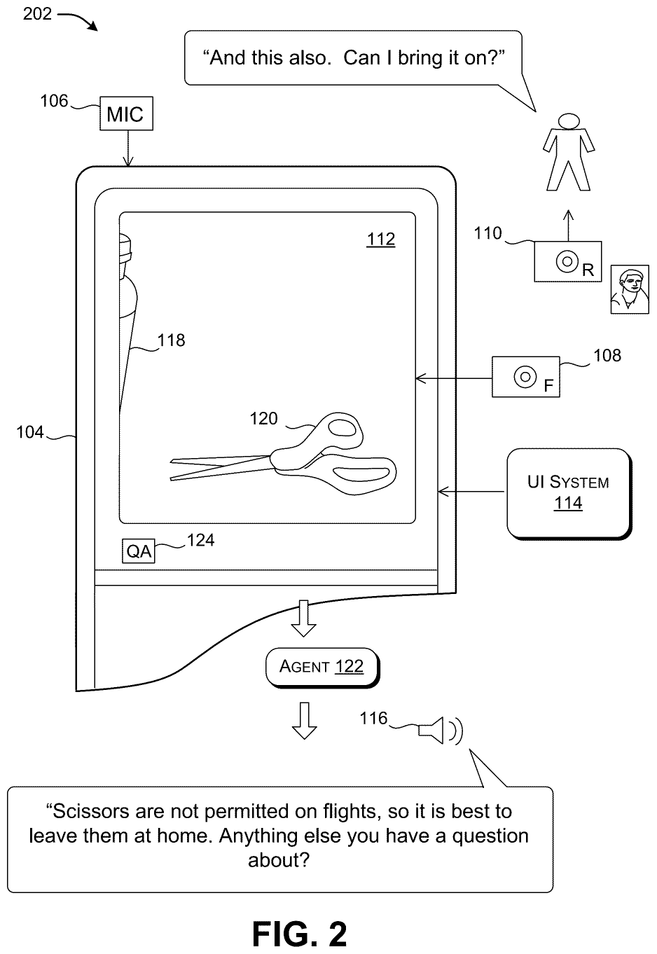

Advancing to FIG. 2, in a second instance of time 202, the user quickly asks a follow-on question about the scissors while shifting the FOV of the client system 104 to capture a more complete representation of the scissors. In this particular example, any pause between the first part of the query (“Can I bring this on my flight”) and the second part of the query (“And this also. Can I bring it on?”) does not exceed the permitted-silence threshold. Thus, the client system 104 will regard the two utterances as part of the same integrated spoken query. In this particular example, upon receiving the audio data and camera image data directed to the scissors, the automated agent 122 sends a reply that informs the user that scissors will not be permitted on flights.

The selective capture of camera images while the user is speaking (and not when the user is silent) reduces the consumption of resources, e.g., by reducing the overall number of camera images that are captured. The selective capture of the camera images while the user is speaking also helps the automated agent 122 correctly interpret a spoken query, e.g., because it reduces the amount of context information that may not be relevant to the spoken query.

In the above example, the client system 104 does not collect camera images from the rear-facing camera 110, relying instead on only one or more camera images captured by the front-facing camera 108. In other examples, the automated agent 210 interprets a question with reference to information collected by a front-facing camera and a rear-facing camera, or just the rear-facing camera. A rear-facing camera image may convey information about a user's facial expression, which may have a bearing on whether the user is expressing satisfaction or dissatisfaction with a prior-delivered reply or something that is observed in the environment. For some queries, the user's appearance is also relevant to the spoken query, as when the user is seeking a piece of clothing that will complement his or her current attire.

In all instances, the automated agent 122 is configured to protect the privacy of individuals. For instance, as a default setting, an automated agent 122 will not recognize the face of another person, unless that other person is recognized as a celebrity or other individual with a predefined public status. The automated agent 122 will also not, as a default setting, recognize personal sensitive information, such as a bank card numbers or license plate numbers. Further, the automated agent 122 allows the user to choose whether they will participate in the collection of camara image data and audio data. The automated agent 122 further allows each individual user to control the manner in which audio data and camera image data are collected, and the manner in which this information is subsequently deleted.

Finally, in FIGS. 1 and 2, the spoken query is structured as an interrogatory. But more generally, a “spoken query” is intended to encompass any utterance that will cause the automated agent 122 to generate a reply. For example, a user may state, “I plan to take these scissors onto my flight today, they don't look that sharp.” This statement is not structured as an interrogatory, but it is a material misstatement that the automated agent 122 will seek to remedy with a corrective reply. In other examples, the automated agent 122 may supplement the user's commentary regarding his or her environment with added information. For example, the user may point the client system 104 at a sunset and comment favorably about its beauty. If so configured, the automated agent 123 may interject information about how smog counterintuitively contributes to the colorfulness of the sunset. In general, the information imparted by a system prompt that is fed to the automated agent 122 controls how the automated agent 122 will respond to different vocal and visual cues.

In other examples, a query begins when the user interacts with a text input device, such as a physical keyboard or user-interface keyboard. The query is considered to remain in progress while the user is interacting with the text input device. The query is considered to terminate when there is a pause in text input that exceeds a prescribed permitted-inactivity threshold. In the same manner described above for voice input, the client system 104 is configured to capture camera images while the text-based query is in progress.

### B. Example in which Image Data Originates from a UI System

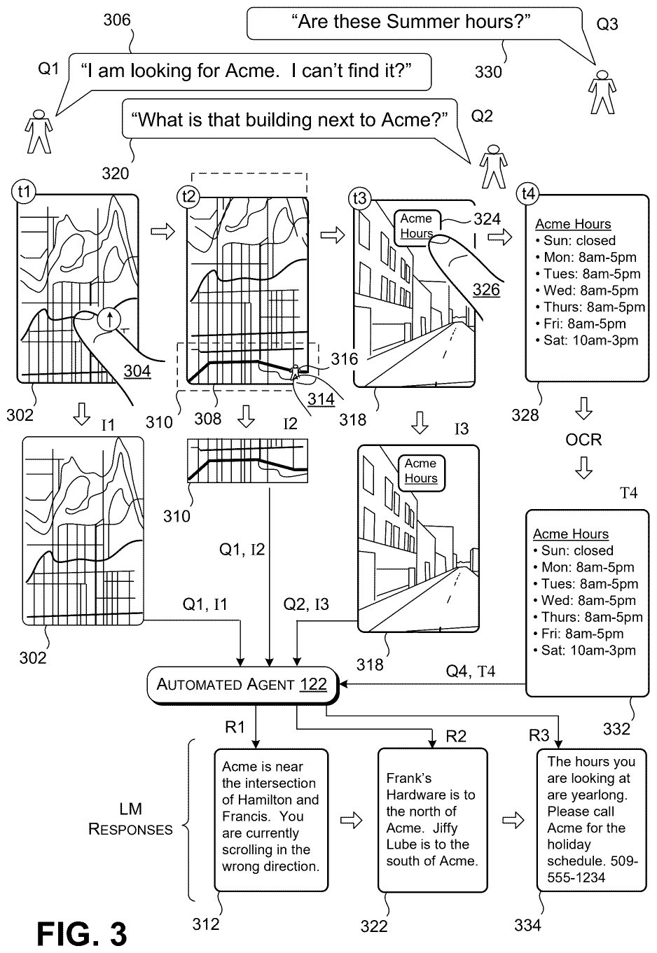

In the example of FIG. 3, a user interacts with one or more applications and/or other programs via a client system while simultaneously asking a question. As in the example of Section A, the client system receives the question via voice recognition, text input device, etc., or any combination thereof. FIG. 3 particularly shows the case in which the client system uses voice recognition to capture spoken questions. While the question is in progress (and a voice signal is detected), the client system captures screen image data that is being presented on a display device by a user interface (UI) system (not shown) at a predetermined image-capturing rate. In some implementations, the client system specifically obtains the screen image data from a screen buffer. A screen buffer refers to any storage device that stores the screen image data that is currently being presented on the display device or is about to be displayed on the display device.

In the particular example of FIG. 3, the intent of a user is to retrieve information from a map application about a particular establishment (“Acme”) in a particular city. A topmost portion of FIG. 3 shows a series of questions that are posed. A second level of FIG. 3 shows a sequence of instances of screen image data that the UI system displays on the display device. A third level shows a sequence of instances of screen image data or text information that the client system sends to the automated agent 122 via the automated interface, along with audio data. A lowest level shows a sequence of responses generated by the automated agent 122 and delivered to the client system.

At a first instance of time (t1), the map application displays first screen image data 302 (I1) on the display device of the client system. The display device has a touch sensitive surface. The user scrolls up on the touch sensitive surface with a finger 304, attempting to find Acme on the map. Simultaneously therewith, the user speaks a first query 306 (Q1), “I am looking for Acme. I can't find it.” At a second instance of time (t2), the map application displays second screen image data 308. As a result of the scrolling movement, the second screen image data shows a portion 310 of screen content (I2) 310 that is not common to the first screen image data 302. In other words, the portion 310 is “new,” and the remaining portion is “old.” The second screen image data 308 also removes another portion (not shown) of screen content that appears in the first screen image data 302 and that has been scrolled off the display device.

In some implementations, the client system captures and forwards screen content subject to the following rules. The client system applies these rules when it is time to sample an instance of screen image data, as governed by the image-capturing rate.

(1) Case A. In this case, the client system concludes that there has been no update to the screen image data since a last sampling time. For example, this case applies when the client system concludes that the screen buffer has not been updated since the last sampling time. In this circumstance, the client system does not capture a new instance of screen image data. Nor does the client system forward any screen image data to the automated agent 122. In other words, the client system suspends the screen image capture and transfer for this instance of time. The client system will, however, forward audio data captured at this time to the automated agent 122.

(2) Case B. In this case, the client system concludes that an entirety, or some prescribed substantial portion, of the screen image data currently being presented on the display device is “new” because it is not shared with a previous instance of screen image data. In this circumstance, the client system forwards a content-bearing message to the automated agent 122 that includes audio data combined with the entire instance of the screen image data that is currently being displayed by the computing device.

(3) Case C. In this case, the client system concludes that a portion of the screen image data presented on the display device at the present time is shared by a previous instance of screen image data, and another portion of the screen image data is not shared by the previous instance of screen image data and is therefore “new.” In some implementations, the UI system of the client system expresses the new portion as a dirty rectangle or other designated area which is stored in the screen image buffer. In this circumstance, the client system sends a content-bearing message to the automated agent that includes audio data combined with just the new portion of screen image content. The client system is also capable of applying additional considerations in determining what portion of image data to send to the automated agent, as described below.

(4) Case D. In this case, the client system determines that a prescribed amount of information being presented by a current instance of screen image data conveys textual information. For example, the client system consults accessibility metadata provided by the application that is displaying the screen image data to determine whether it contains textual information. (Accessibility metadata is typically provided by an application to assist individuals with vision and/or hearing impairments in interpreting screen image data.) In other implementations, the client system uses a neural network to generate a binary decision that indicates whether or not the screen image data includes textual content. Upon reaching a conclusion that the screen image data contains textual information, the client system applies an optical character recognition (OCR) technique to convert the screen image into text. The client system 102 then sends the text in lieu of the screen image data to the agent interface.

The above provisions reduce the amount of information that passes to the agent interface and the automated agent 122. In doing so, the multi-modal agent system reduces the consumption of communication resources, memory resources, and processor resources, while also reducing latency (because there is, on average, less information that needs to be transferred to the automated agent 122).

In the example of FIG. 3, the client system captures and forwards two content-bearing messages while the user is speaking the first question 306 (Q1), separated in time by an interval determined by the image-capturing rate. That is, at the first instance of time (t1), the client system determines that Case B applies because the first instance of screen image data 302 (I2) presented on the display device has no portion in common with a prior instance of screen image data (not shown). The client system sends a first content-bearing message to the automated agent 122 that includes a first portion of the first query (Q1) and the first instance of screen image data 302.

At the second instance of time (t2), the client system determines that Case C applies because only a portion of screen image data 310 (I2) has been updated in the second instance of screen image data 308. The client system sends a second content-bearing message to the automated agent 122 that includes a remaining portion of the first query (Q1) and the portion of screen image data 310 (I2).

In response to the first content-bearing message and the second content-bearing message, the automated agent 122 generates and provides a first response (R1) 312, which reads, “Acme is near the intersection of Hamilton and Francis. You are currently scrolling in the wrong direction.” The automated agent 122 bases this response (R1) 312 on the following contextual factors: a) the user is searching for a particular company; b) the user is currently looking for the company in a particular neighborhood of a particular city; and c) the user is currently scrolling a map of the city in a particular direction.

In the example of FIG. 3, the client system next detects that the user has activated a street view mode by using a finger 314 to select an icon 316 that appears in the instance of screen image data 308. This causes the map application to present third screen image data 318 (I3) on the display device. At a third instance of time, while the third screen image data 318 (I3) is being presented, the user asks a second question 320 (Q2), “What is that building next to Acme?” The intent of the user here is to identify the establishments shown in the third screen image data 318 (I3) located to the north and south of the Acme building location.

The client system again determines that the Case B applies. As such, the client system sends a third content-bearing message to the automated agent 122 that includes the audio data associated with the second question 320 (Q2) and the entirety of the screen image data 318 (I3). In response, the automated agent 122 generates the reply 322 (R2): “Frank's Hardware is to the north of Acme. Jiffy Lube is to the south of Acme.”

The client system next detects that the user selects an icon 324 in the third screen image data 318 (I3) with a finger 326. The map application responds by showing fourth screen image data 328 (I4). At a fourth instance of instance of time (t4), the client system detects that the user has spoken a third question 330 (Q3) that reads, “Are these Summer hours?” The client system determines that the fourth instance of screen image data 328 (I4) contains only text information, or is mostly composed of the text information 332. This corresponds to Case D. In response, the client system uses optical character recognition to convert the screen image data 328 (I4) to text information 332, e.g., expressed using character identifiers associated with the characters in the text information. The client system sends a fourth content-bearing message to the automated agent 122 that includes the audio data for the third question 330 (Q3) together with the text information 332 in lieu of the fourth screen image data 328 (I4). The automated agent 122 responds with a third response 334 (R3): “The hours you are looking at are yearlong. Please call Acme for the holiday schedule.” The multi-modal agent system further reduces resource usage by sending the text information 332 instead of the larger-sized fourth screen image data 328.

In some examples, the client system receives the three questions (306, 320, 330) in quick succession without the permitted-silence threshold being exceeded at any point. In response, the automated agent 122 treats the three questions (306, 320, 330) as different parts of one integral master query. In other examples, the permitted-silence threshold is exceeded at least once in the entire course of the three questions. In response, the automated agent 122 treats at least one of the three questions (306, 320, 330) as a separate query from the others. Nevertheless, even in this case, the automated agent 122 can be configured to maintain a memory of the context imparted by one or more preceding questions.

In the above example, the client system bases its decision of what image content to send to the automated agent 122 on an assessment of what portion of the screen image data has been updated at a current time relative to an immediately prior instance of time. Alternatively, or in addition, other implementations use one or more other factors in selecting portions of the screen image data. For example, another implementation selects a portion of screen image data that originates from only the active application with which the user is currently interacting. In some implementations, the client system operates in this mode based on a configuration setting that selects this mode. Other implementations allow an administrator and/or user to select criteria that discriminate among different types of screen image data. For instance, for a document-processing application, a configuration interface allows a user to choose whether or not the screen image data sent to the automated agent 122 should include tool bar graphics or other tangential screen items.

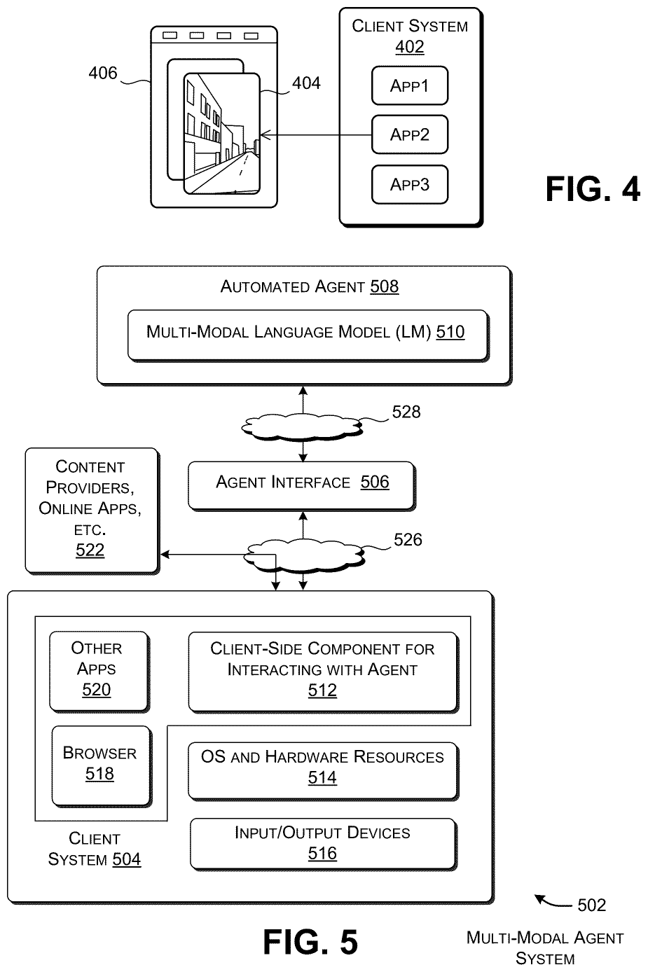

FIG. 4 shows an example of the above manner operation. An application “App2” running on a client system 402 presents screen image data in a window 404, within more encompassing screen image data 406. For instance, the more encompassing screen image data 406 includes one or more other windows associated with other active applications and/or supplemental screen content (such as a control toolbar displayed by an operating system). For one configuration setting, the client system 402 only forwards the screen data in the window 404 to the agent interface. For another configuration setting, the client system 402 provides screen image data for the more encompassing screen image data 404. Generally, different implementations are capable of applying implementation-specific considerations in determining what constitutes significant image data to be sent to the automated agent.

### C. System Overview

FIG. 5 shows one implementation of a multi-modal agent system 502 for producing the user experiences shown in FIGS. 1-4. The multi-modal agent system 502 includes a client system 504 (e.g., a smart phone), an agent interface 506, and an automated agent 508. The automated agent 508, in turn, uses a multi-modal language model 510 to generate its replies.

In some implementations the client system 504 is an integrated handheld user device, such as a smartphone. The client system 504 includes a client-side component (referred to as the “client component” 512 below for brevity) for interacting with the automated agent 508. In some implementations, the client component 512 is implemented by an application (“app”) installed on the client system 504. The client system 504 also includes an operating system (OS) and hardware resources 514, and plural input/output devices 516. The plural input devices include the microphone(s) 106 and the cameras (108, 110). The plural output devices include the display device 112 and the speaker(s) 114.

In some implementations, the client system 504 includes a browser application 528 and/or one or more other applications 520. Alternatively, or in addition, the client system 504 also interacts with zero one or more content providers and/or online applications 522. Any local or online application or operating system program is capable of presenting screen image data on the display device of the computing system 504.

In some implementations, the agent interface 506 is implemented by one or more servers, which provide service to one or more client systems. Likewise, the automated agent 508 is implemented by one or more servers, which provide service to one or more client systems. Any type of communication conduit 526 communicatively couples each client system 504 and the agent interface 506. For example, the communication conduit 526 represents a wide area network (e.g., the Internet), a local area network, or a point-to-point link. Similarly, any type of communication conduit 528 communicatively couples the agent interface 506 and the automated agent 508. Any two components of the multi-modal agent system 502 may be co-located and/or geographically separated. Any two or more components of the multi-modal agent system 502 may be administrated by a single entity and/or two or more entities.

In some implementations, the multi-modal agent system 502 implements interaction between the components shown in FIG. 1 using any stateful communication protocol, such as the WebSocket protocol. General information regarding this protocol is available at Melnikov, et al., “The WebSocket Protocol,” Internet Engineering Task Force (IETF), RFC 6455, ISSN: 2070-1721, December 2011, 71 pages. A stateful communication session is a session in which information regarding what has occurred in the course of the session is retained. This contrasts with a stateless protocol, such as HTTP, in which individual transactions are memoryless and generally executed without reference to any other transactions.

Overall, the multi-modal agent system 502 provides a framework that enables the client system 504 to interact with the automated agent 508 having multi-modal capabilities without overwhelming the resources of either the client system 504 or the automated agent 508. The characteristics of the multi-modal agent system 502 that contribute to this technical advantage are described in the following sections.

### D. Illustrative Process Flows

In general, the process flows described in this section are representative of one illustrative implementation. Other implementations vary the order in which operations are performed, including performing certain operations in parallel fashion. Further, the figures are described for the illustrative scenario in which a user inputs queries through speech. But the same principles extend to the example in which the user engages the automated agent 508 by inputting a text-based query.

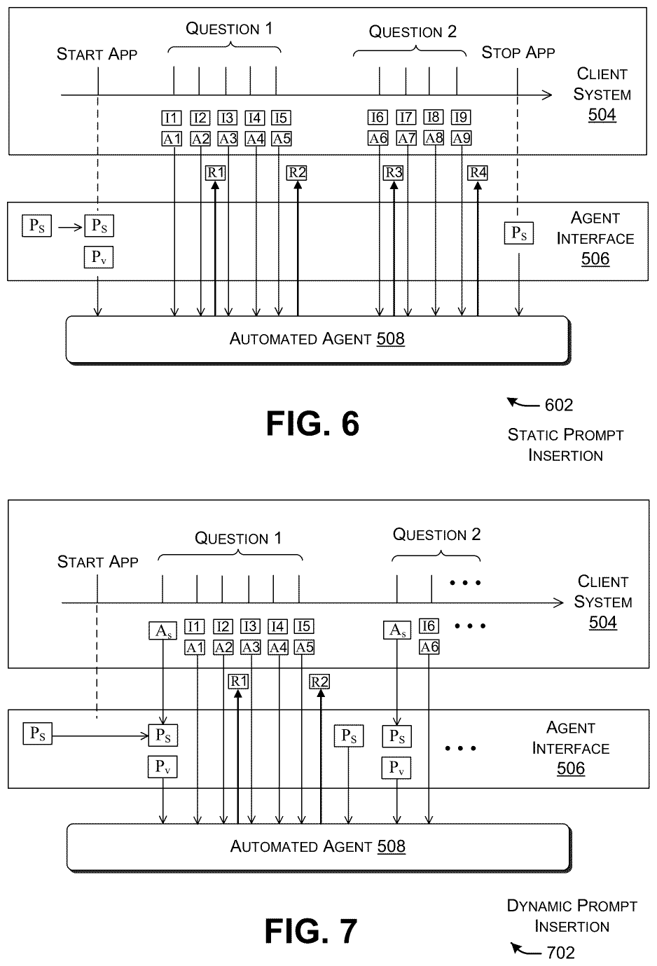

FIG. 6 shows one manner of operation of the multi-modal agent system 502 of FIG. 5 in a static prompt insertion mode. At a first instance of time, the client system 504 invokes the question-answering application. The client system 504 and agent interface 506 then cooperate to set up a stateful communication session, which remains in place until the application is shut down. At this juncture, the agent interface 506 also determines that the client system 504 has image-capturing capabilities, or the user has activated a camera. In response, the agent interface 506 supplements a system prompt (P_{S}) with a vision prompt (P_{V}), to produce an updated system prompt. The vision prompt contains information that instructs the language model 510 to process image data that is sent to it in a particular manner. The system prompt (which is also referred to as a base prompt herein) contains more general instructions regarding the task that the language model 510 is being instructed to perform. For example, the system (base) prompt may describe a preferred format that the automated agent 508 is to use when responding to an instance of data that is sent to it. The system (base) prompt may also instruct the automated agent 508 to ignore content that would jeopardize the privacy of one or more individuals. The agent interface 506 sends the updated system prompt (P_{S}+P_{V}) to the language model 510, e.g., where “+” represents concatenation.

The client system 504 then sends a set of five content-bearing messages to the automated agent 508 via the agent interface 506, followed by a set four content-bearing messages. The first set of content-bearing messages convey a first question, while the second set of content-bearing messages convey a second question. More specifically, within each set, images are captured at the image-capturing rate. The content-bearing messages in each set are considered as part of one question because there is no period of silence (or text entry inactivity) that exceeds the permitted silence/inactivity threshold(s). The first question is considered distinct from the second question because there is a period of silence/inactivity that exceeds the applicable threshold(s). Assume that the automated agent 508 provides four replies over the course of the first question and the second question.

The stateful session ends when the user shuts down the application or some other termination event is detected. At this time, the agent interface 506 sends a further-updated prompt to the automated agent 508 that informs the automated agent 508 that it is to henceforth use only the system (base) prompt (P_{S}).

FIG. 7 shows one manner of operation of the multi-modal agent system 502 of FIG. 5 in a dynamic prompt insertion mode. In this example, the user performs the same actions in this mode as the static prompt insertion mode. But in the dynamic prompt insertion mode, the agent interface 506 dynamically updates the system (base) prompt (P_{S}) to include the vision prompt (P_{V}) when the beginning of a question is detected (A_{S}). The agent interface 506 dynamically removes the vision prompt (P_{V}) when the question ends. In the particular example of FIG. 7, the client system 504 performs the prompt update operations for both the first question and the second question.

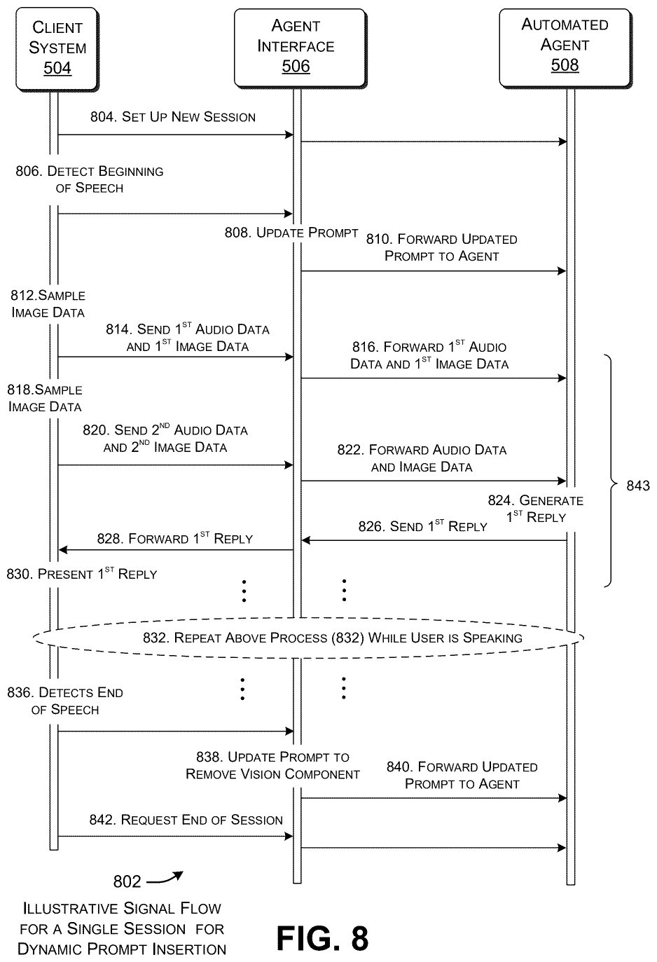

FIG. 8 is a signal diagram 802 that shows additional details regarding the operation of the multi-modal agent system 502 of FIG. 5 in the dynamic prompt-insertion mode. In operation 804, an application associated with the client component 512 is started. This causes the multi-modal agent system to set up a stateful communication session, which remains in place until the application is shut down.

Further, the client system 504 provides metadata (e.g., expressed as binary and/or multi-value flags) to the agent interface 506 that identifies the client system's type and other characteristics. For instance, the client system 504 informs the agent interface 506 what kind of device it is and whether it has image-capturing capabilities. Other implementations extend this behavior to selections made by a user that affect the status of the camera(s). For example, the client system 504 may notify the agent interface 506 when a camera is turned on or off.

In some implementations, the agent interface 506 responds to the client system 504 by instructing the client system 504 to sample images, when a conversation starts, at a specified sampling rate. In some examples, the image-capturing rate is constant, e.g., specifying that an image is to be captured every three seconds while the user is speaking. In other examples, the agent interface 506 instructs the client system 504 to dynamically select the image-capturing rate based on a current rate-of-change measure. But even in this case, the agent interface 506 may establish the acceptable bounds of sampling rates, e.g., by specifying that the image-capturing rate should be no less than 0.5 seconds and no more than 6 seconds.

In operation 806, the client system 504 detects the start of a spoken message, as when, in the scenario of FIG. 1, the user speaks the first word of “Can I bring this on my flight?” In operation 808, for the dynamic prompt-insertion mode, the agent interface 506 dynamically adds an instruction to a system (base) prompt that informs the automated agent 508 how it is expected to process image data that is subsequently sent to it. This instruction is referred as the vision prompt. In operation 810, the agent interface 506 forwards the updated system prompt to the automated agent 508, which thereafter uses it to interpret data that is sent to it.

In operation 812, the client system 504 samples an instance of image data from either a camera (or cameras) or the UI system. Among other functions, this operation includes scaling the width of a captured image to 512 pixels and the height of the captured image to a value given by the width value and the aspect ratio of the display device of the client system 504, thereby reducing the resolution of the captured image and the number of pixels it contains. For instance, for an aspect ratio of 1:2, the height would be 1024 pixels. In operation 814, the client system 504 sends a first content-bearing message including audio data and the resolution-reduced image data to the agent interface 506. In operation 816, the agent interface 506 forwards the content-bearing message to the automated agent 508. In general, a content-bearing message may refer to one signal that conveys a package of both audio data and image data, or two or more signals that separately convey the audio data and the image data. Operations 818, 820, and 822 repeat the operations of 812, 814, and 816 with respect to a newly sampled instance of audio data and image data. The client system 504 initiates operations 818, 820, and 822 at a timing given by the image-capturing rate.

In operation 824, the automated agent 508 uses the language model 510 to generate a reply to the first content-bearing message and/or the second content-bearing message. In general, the language model 510 operates on prompt information that expresses a context window that may encompass one or more content-bearing messages. In some cases, the reduction in resolution of the image data increases the breadth of image content that is described in a single context window, which, in turn, improves the ability of the language model 510 to provide a correct reply to audio data and image data. Increased breadth means, for example, that a single context window having a fixed size is able to represent more parts of a single instance of image data or more parts of plural instances of image data (compared to the case in which the image data is not reduced in resolution). In operations 826 and 818, the automated agent 508 sends its reply to the client system 504 via the agent interface 506. In operation 830, the client system 504 presents (e.g., displays or vocalizes) the reply. For example, the reply may correspond to the audio reply shown in FIG. 1 and the reply 312 shown in FIG. 3.

Notation 832 generally indicates that the above series of operations 834 may be repeated one or more times during the course of the spoken query, so long as an active voice signal continues to be detected with no pause exceeding the permitted silence threshold.

In operation 836, the client system 504 detects the end of the spoken query and notifies the agent interface 506 of this event. In operation 838, the agent interface 506 responds by removing the vision prompt from the system prompt, to produce a further-updated system prompt. In operation 840, the agent interface 506 forwards the further-updated system prompt to the automated agent 508.

In a static prompt-insertion mode (not shown), the agent interface 506 immediately updates the system prompt with a vision prompt upon the launch of the application, and forwards the updated system prompt to the automated agent 508. The automated agent 508 thereafter uses this updated system prompt to process whatever data is subsequently fed to it. In other words, in the static prompt-insertion mode, the multi-modal agent system 502 will not dynamically add and remove vision prompts at the start and ending of spoken queries.

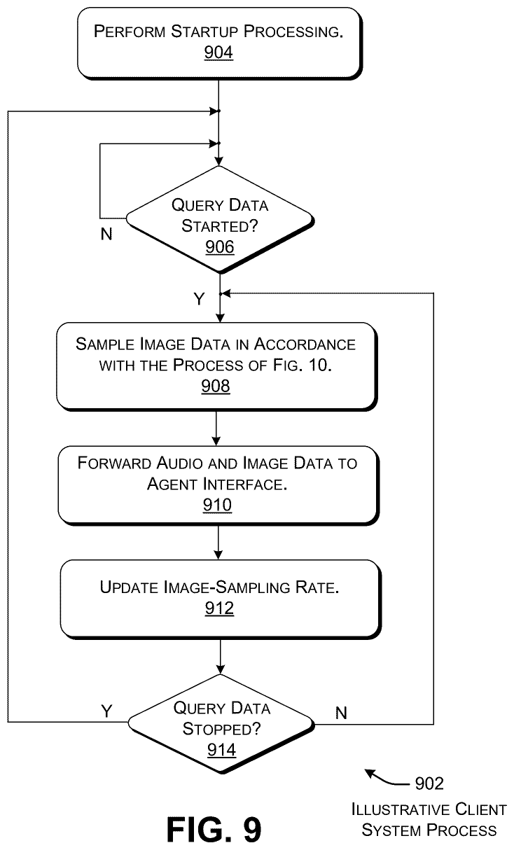

FIG. 9 is a process 902 that describes the operations of the client system 504 of FIG. 5. In operation 904, the client system 504 starts the communication application. The client system 504 sets up a stateful communication session and notifies the agent interface 506 of its capabilities. In some implementations, the client system 504 receives a static image-capturing rate from the agent interface 506 at this time, or an instruction to operate using a dynamic image-capturing rate, subject to specified constraints.

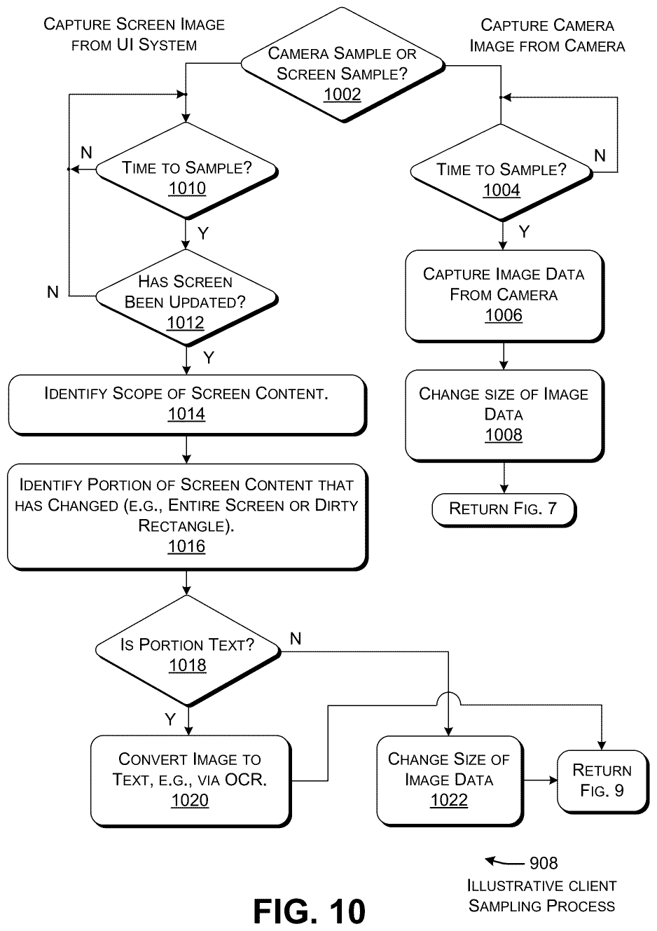

In block 906, the client system 504 detects whether a spoken query has commenced. In block 908, the client system 504 samples an image from either the camera (e.g., the camera buffer) or the UI system at a timing given by the specified image-capturing rate. FIG. 10 provides details regarding one implementation of block 908. In block 910, the client system 504 forwards the captured instance of audio data and image data to the agent interface 506.

In block 912, if the dynamic sampling mode is invoked, the client stem 904 updates the rate-of-change measure based on the amount of change in image content from sampled image to sampled image. The client system 504 then updates the image-capturing rate as a function of the rate-of-change measure.

In block 914, the client system 504 detects whether the ongoing spoken query has ended. If so, the client system 504 returns to block 906, upon which the client system 504 waits for the next query to begin. If the current query has not ended, then the process 902 returns to block 908, in which another instance of image data and audio data are captured.

FIG. 10 shows one manner of operation of the sampling operation performed in block 908 of FIG. 9. In block 1002, the client system 504 determines whether it should sample an instance of image data from a camera (or cameras) (e.g., from the camera buffer) or from the UI system (e.g., from the screen buffer). The client system 504 makes this determination based on a mode setting and/or based on any one or more contextual factors (e.g., how the user is currently interacting with the client system 504).

Assume that the client system 504 determines, in block 1002, that it should sample an instance of camera image data from the camera. In block 1004, the client system 504 determines, based on the specified image-capturing rate, whether it is time to capture an image from the camera. If not, the client system 504 continues to wait for the sampling time to arrive. If the time has arrived, then, in block 1006, the client system 504 captures an instance of camera image data from the camera. In block 1008, the client system 504 reduces the resolution of the captured camera image data, e.g., by downscaling and/or compression. For example, the client system 514 reduces the width of a captured image to a predetermined value (e.g., 512) and then reduces the height based on the predetermined value and the aspect ratio of the display device of the client system 504. Overall, by reducing the resolution of image data, the multi-modal agent system 502 is able to reduce the amount of data that is transferred to the agent interface 506 and the automated agent 508, and thereby increase the efficiency and speed of this transfer.

Alternatively, the client system 504 determines in block 1002 that it should sample an instance of screen image data from the UI system. The image-capturing rate for the screen image data may be the same as or different than the image-capturing rate for the camera image data. In block 1010, the client system 504 determines whether it is time to sample the screen image data. If not, the client system 504 continues to wait for the sampling time to arrive. If the time has arrived, then, in block 1012, the client system 504 determines whether the display device has been updated since the last sampling time. If not, the client system 504 omits the step of capturing an instance of screen image data; the client system 504 then waits for a next time to sample the UI system has arrived.

Alternatively, if block 1012 is answered in the affirmative, then the client system 504 determines a scope of screen image data to capture. For example, the client system 504 determines whether it should sample an instance of screen image data from just the application with which the user is currently interacting, or all of the screen image data that is presented on a display device at this time. The client system 504 performs this determination based on a configuration setting and/or based on context-based signals (e.g., based on the application with which the user is currently interacting).

In block 1016, the client system 514 determines whether only a portion of the screen image data has changed. In some implementations, the client system 514 makes this determination by comparing an immediately previous instance of screen image data with an instance of screen image data that is currently being presented. The portion that has changed is the portion of the current instance screen image data that is not shared by the previous instance of screen image data. In some implementations, the UI system retains the current and previous instances of screen image data in a front and back screen buffers, respectively (not shown). In other implementations, the UI system already identifies the portion of the current screen image data that has been updated, e.g., as expressed as a “dirty rectangle” or other designated area. This rectangle delineates the scope of the screen image content that is new within the entirety of the screen image content currently being displayed. Note that block 1016 has been described in the context of processing screen image data. But the same processing can be performed, although not shown, for successive instances of camera image data captured by a camera.

In block 1018, the client system 504 determines whether the captured screen image data contains text information, or more specifically contains a specified amount (e.g., percentage) of text information. The client system 504 can make this determination by consulting accessibility metadata provided by the application which is presenting the screen image data. Alternatively, or in addition, the client system 504 uses a machine-trained neural network to classify the instance of screen image data as text or not text.

If block 1018 is answered in the affirmative, in block 1020, the client system 504 uses any optical character recognition technique to convert the screen image data to text (if this operation has not already been performed as part of block 1018). The client system 504 returns to FIG. 9, in which the text is sent to the agent interface 506 in lieu of the screen image data.

If block 1018 is answered in the affirmative, the client system 504 reduces the resolution of screen image data in block 1022 in the same manner described above for block 1008. The client system 1002 then returns to the process 902 of FIG. 9, in which the reduced-resolution screen image data is sent to the agent interface 506.

Note that FIG. 10 corresponds to an example in which the client system 504 is the entity which reduces the resolution of the captured image data. Alternatively, or in addition, the agent interface 1006 performs this resolution reduction operation.

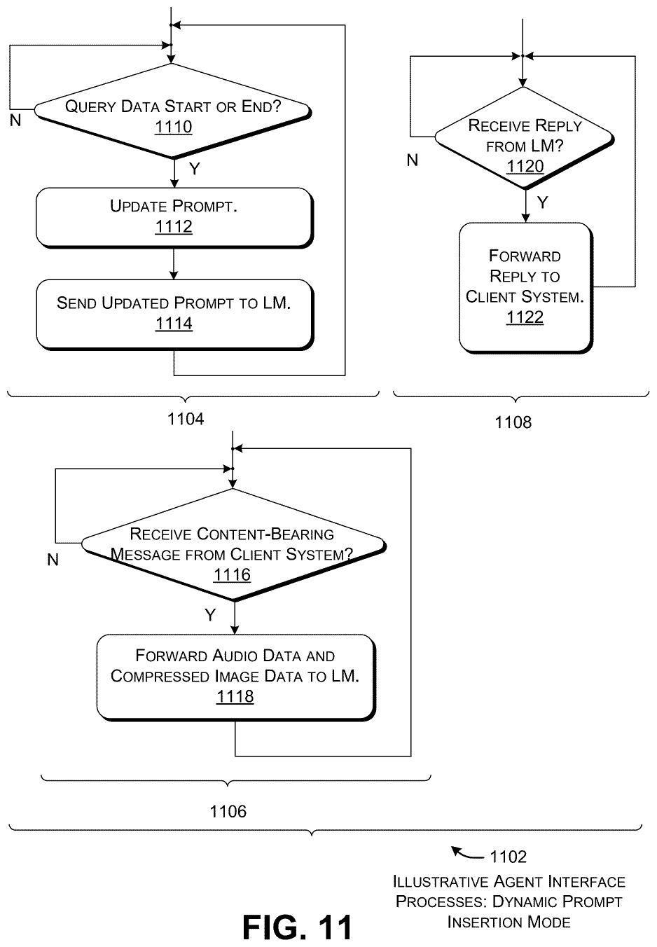

FIG. 11 show processes 1102 that describe the operations of the agent interface 506 of FIG. 5. That is, the agent interface 506 performs the process 1104 to update a system prompt. The agent interface 506 performs a process 1106 to forward captured data to the automated agent 508. The agent interface 506 performs a process 1108 to process replies generated by the automated agent 508.

In block 1110 of process 1106, the agent interface 506 determines whether a query has started or ended. If so, in block 1112, the agent interface 506 updates the system prompt, e.g., by either adding the vision prompt to the system prompt when a query has started or removing the vision prompt from the system prompt when the query has ended. These operations are more specifically performed in the dynamic prompt insertion mode.

In block 1116 of process 1106, the agent interface 506 determines that a content-bearing message has been received from the client system 504. In block 1118, the agent interface 506 forwards the received audio data and the image data to the automated agent 508.

In block 1120 of process 1108, the agent interface 506 determines whether it has received a reply from the automated agent 508. In so, in operation 1122, the agent interface 506 forwards the reply to the client system 504.

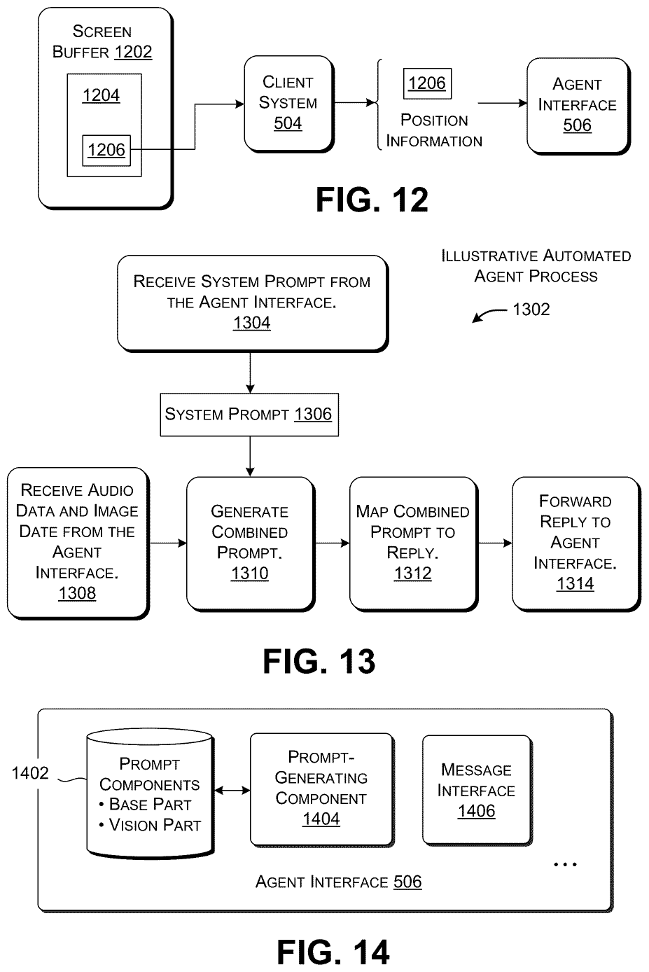

FIG. 12 shows an example of the transfer of a portion of screen image data by the client system 504 to the agent interface 506 of FIG. 5. Here, a screen buffer 1202 stores a current instance of screen image data 1204. The client system 504 determines that a portion 1206 is the only part of the screen image data 1204 that is new, meaning that it is not shared with an immediately preceding instance of screen image data (not shown). The remainder of the screen image data 1204 is old, meaning that it is shared with the preceding instance of screen image data. In some implementations, the UI system of the client system 504 specifies this portion 1206 via a “dirty rectangle.” The client system 504 forwards the portion 1206 to the agent interface 506 instead of the entire instance of screen image data 1204. The client system 504 also forwards position information that describes the position of the portion 1206 within the entire instance of screen image data 1204.

FIG. 13 is a process 1302 that describes the operation of the automated agent 508 of FIG. 5. In block 1304, the automated agent 508 receives and stores an updated system prompt 1306. That is, in the dynamic prompt-insertion mode, the updated system prompt 1306 will include a vision prompt at the start of a query. At the end of the query, the updated system prompt 1306 will include a system prompt from which the vision prompt has been recently removed. But in the static prompt-insertion mode, the updated system prompt 1306 containing the vision prompt will remain in place as long as the application session is open.

In block 1308, the automated agent 508 receives a content-bearing message from the agent interface 506 that includes an instance of audio data and image data. In block 1310, the automated agent 508 produces combined input information, e.g., by concatenating the updated system prompt 1006 with tokens that express the audio data and image data. In block 1012, the automated agent 508 maps the combined input information to a reply. In block 1014, the automated agent 508 forwards the reply to the client system 504 via the agent interface 506.

### E. Individual Components of the Multi-Modal Agent System

FIG. 14 shows one implementation of the agent interface 506 of FIG. 5. A data store 1402 stores a base prompt and a vision prompt. The vision prompt includes instructions that govern the interpretation of image data. The base prompt includes general instructions that apply to all data. A prompt-generating component 1404 produces an updated prompt, in the dynamic prompt-insertion mode, by concatenating the base prompt with the vision prompt (at the start of a spoken query) and removing the vision prompt (at the end of a spoken query). A message interface 1406 serves as a mechanism for exchanging information with the client system 504 and the automated agent 508.

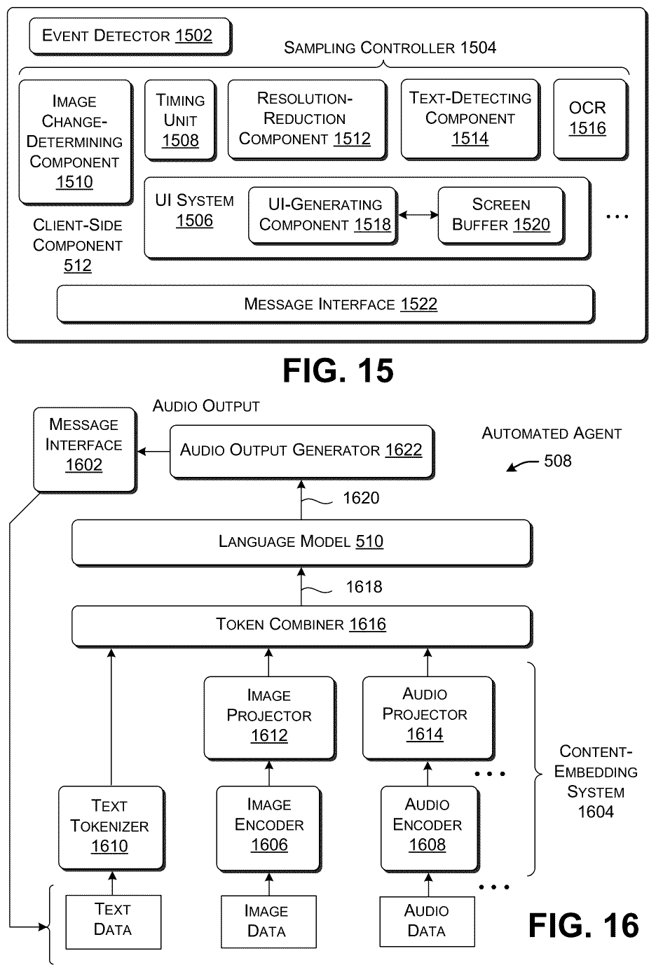

FIG. 15 shows one implementation of the client system 504 of FIG. 5. An event detector 1502 detects the start and end of a spoken query. In some implementations, the event detector 1502 detects the start of a spoken query using any speech recognition algorithm, such as a Hidden Markov Model (HMM) recognition algorithm. Upon detecting sounds that maps to a word or other linguistic unit, the event detector 1502 registers the start of a spoken query. The event detector 1502 detects the end of a spoken query when there is a pause in speaking that exceeds a predetermined-silence threshold. Other implementations provide more complex assessments of whether two utterances form a single spoken query, e.g., by using a neural network to map the two utterances into two respective distributed vectors, and using some distance metric (e.g., cosine similarity) to assess the semantic similarity between the two vectors. Further, the client system 504 can include another event detector (not shown) that detects the start and end of a text-based query. This event detector determines whether there is requisite continuity among input keystrokes or UI actions.

A sampling controller 1504 performs all aspects of sampling of instances of image data, either from a camera or from a UI system 1506, or from both the camera and the UI system 1506. As one part of this sampling function, a timing unit 1508 determines when an instance of image data is to be captured based on a image-capturing rate. In the static mode, the timing unit 1508 uses a fixed image-capturing rate given by the agent interface 506. In the dynamic mode, the timing unit 1508 dynamically updates the image-capturing rate based on a change in image content in the succession of instances of image data that are captured. An image change-determining component 1510 performs this analysis. In some implementations, the image change-determining component 1510 determines an extent of change based on the size of the dirty rectangle shown in FIG. 12. In other examples, the image change-determining component 1510 independently measures the change in image content between the last two captured images, which is used by the timing unit 1508 to determine a current image-sampling rate. Or the image change-determining component 1510 determines the image-to-image differences between successive pairs of images for a set of N images, and then generates an average rate-of-change measure for this set. The image change-determining component 1510 measures the difference between any two images using any similarity-assessing metric (structural similarity index measure (SSIM), L2 norm, etc.), or any similarity-assessing algorithm (sum-square difference, cross-correlation, feature-based comparison, template matching, histogram of gradients, SIFT, etc.)

The sampling controller 1504 also relies on the image change-determining component 1510 to determine the portion of screen image data that is to be sent to the agent interface 506. For example, in the example of FIG. 3, the image change-determining component 1510 determines that only the portion 310 needs to be sent to the agent interface 506, rather than an entirety of the screen image data 308

A resolution-reduction component 1512 uses any resolution-reduction algorithm to reduce the resolution (dimensions) of a received image, which decreases the dimensions of the received image and the number of pixels it contains. For instance, the resolution-reduction component 1512 can use any combination of down-scaling techniques and/or image compression techniques. Illustrative down-scaling techniques include various nearest-neighbor algorithms, various interpolation algorithms (e.g., bilinear, bicubic), various convolution approaches, etc. Illustrative compression techniques include, for example, PNG, WebP lossless, etc. (for lossless compression), and JPEG, WebP lossy, etc. (for lossy compression).

A text-detecting component 1514 determines whether an instance of image data that has been captured is predominantly text. Different implementations of this function have been described above in the context of the explanation of FIG. 10. An OCR component 1516 converts image data to text using any optical character recognition technology, e.g., a Hidden Markov Model (HMM) or a neural network technique.

In some implementations, the UI system 1506 includes a UI-generating component 1518 for presenting display information on a display device based on a screen image data in a screen buffer 1520. A message interface 1522 exchanges information with the agent interface 1506.

FIG. 16 shows one implementation of the automated agent 508 of FIG. 5. In some implementations the automated agent 508 incorporates a publicly available multi-modal model, such as the Phi-4 model described in Abouelenin, et al., “Phi-4-Mini Technical Report: Compact yet Powerful Multimodal Language Models via Mixture-of-LoRAs,” arXiv, arXiv:2503.01743v1 [cs.CL], Mar. 3, 2025, 39 pages, or the multi-modal model described in Xie, et al., “Mini-Omni2: Towards Open-source GPT-4o with Vision, Speech and Duplex Capabilities,” arXiv, arXiv:2410.11190v3 [eess.AS], Nov. 5, 2024, 13 pages.

With respect to the specific implementation shown in FIG. 16, a message interface 1602 receives each content-bearing message and each management-related message sent by the agent interface 506. The message interface 1602 also provides a reply generated by the automated agent 508 to the agent interface 506. Assume that, for a particular forward pass through the layers of the automated agent 508, the automated agent 508 processes an instance of audio data and image data. In some implementations, the automated agent 508 is also capable of processing other types of content, such as text data and video data.

A content-embedding system 1604 maps the different kinds of data to embeddings in the same vector space (e.g., a text-based vector space originally created for representing the semantics of words and phrases). The content-embedding system 1604 includes an image encoder 1606 for mapping each image into image tokens. In some examples, the image encoder 1606 breaks an image input image into a series of image patches, such as 16 image patches. The image encoder 1606 then uses any kind of neural network to map the image tokens into respective image embeddings. For example, the neural network is a convolutional neural network (CNN) or a transformer language model. Background information regarding the general topic of encoding image content can be found in Dosovitskiy, et al., “An Image is Worth 16×16 Words: Transformers for Image Recognition at Scale,” arXiv, arXiv:2010.11929v2cs.CV], Jun. 3, 2021, 22 pages. In other examples, the image encoder 1606 maps individual pixels in an input image into respective image embeddings, e.g., using a CNN.

An audio encoder 1608 converts a stream of raw audio data into audio embeddings. For example, the audio encoder 1608 converts the audio data into a stream of audio features, organized into a series of audio frames. For instance, the audio features correspond to Mel-frequency cepstral coefficients (MFCCs). The audio encoder 1608 then maps the audio features into audio embeddings using any kind of neural network. In other examples, the audio encoder 1608 produces a logarithm melspectrogram based on the audio data, and then partitions the melspectrogram into individual patches, akin to the above-summarized case of image processing. The individual patches constitute audio tokens. The audio encoder 1608 then uses any type of neural network (e.g., a transformer-based model) to convert the audio tokens into the audio embeddings. In other examples, the content-embedding system 1604 uses a publicly available speech encoder, such as the WHISPER encoder provided by Open AI of San Francisco, California, and described in Radford, et al., “Robust Speech Recognition via Large-Scale Weak Supervision,” arXiv, arXiv:2212.04356v1, Dec. 6, 2022, 28 pages. In other implementations, a speech-to-text converter first converts the audio data into text data, and then uses the text encoder 1610 to produce the audio embeddings.

The text encoder 1610 maps text data (if used) into text embeddings. The text encoder 1610 performs this task using any tokenizing algorithm, such as the byte pair encoding (BPE), WordPiece, or SentencePiece algorithms. The text encoder 1610 maps codes associated with the text tokens into text embeddings, e.g., using a machine-trained linear transformation.

An image projector 1612 maps the vision embeddings produced by the image encoder 1606 into embeddings in the same vector space as the text encoder 1610. Similarly, an audio projector 1614 maps the audio embeddings produced by the audio encoder 1608 into the same vector space as the text encoder 1610. A token combiner 1616 combines the different kinds of tokens together (e.g., via concatenation), to form combined input information 1618. The combined input information 1618 is encoded with position information that describes the position of individual tokens in a sequence of tokens, e.g., by describing the position of a particular image patch within an image.

The language model 510 maps the combined input information 1618 into output text information 1620. An audio output generator 1622 converts the output text information into a reply. In some examples, the audio output generator 1622 includes any type of speech synthesizer for converting the text information 1020 into a speech information.

### F. Illustrative Language Model

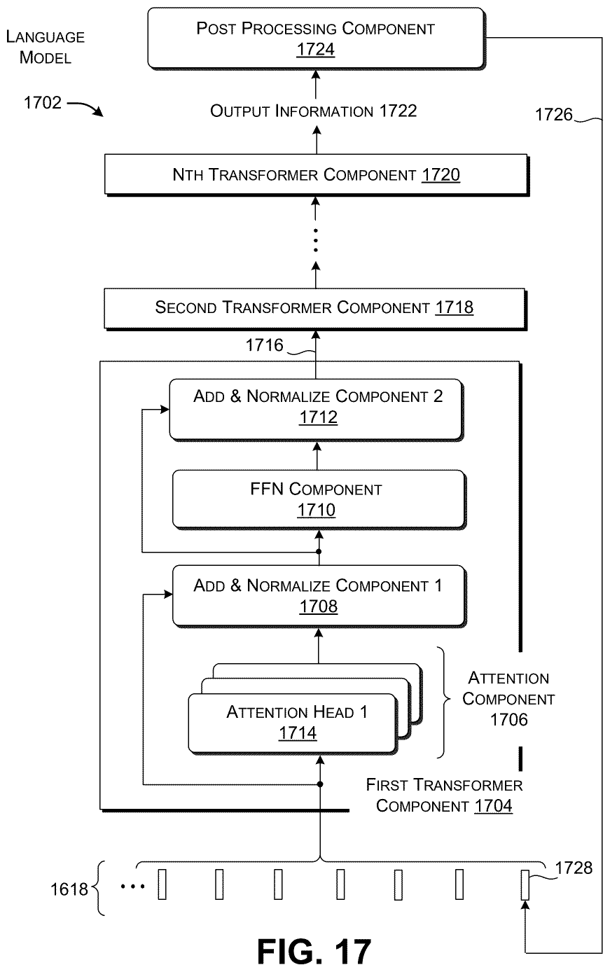

FIG. 17 shows a transformer-based language model (“language model”) 1702 that represents one implementation of the language model 510 of FIG. 5. The language model 1702 is composed, in part, of a pipeline of transformer components, including a first transformer component 1704. FIG. 17 provides details regarding one way to implement the first transformer component 1704. Although not specifically illustrated, other transformer components of the language model 1702 have the same architecture and perform the same functions as the first transformer component 1704 (but are governed by separate sets of weights).

The language model 1702 commences its operation with the receipt of the combined input information 1618. As described above, the combined input information 1618 describes a combination of embeddings originating from at least the audio data and the image data. A first transformer component 1704 includes, in order, an attention component 1706, a first add-and-normalize component 1708, a feed-forward neural network (FFN) component 1710, and a second add-and-normalize component 1712.

The attention component 1706 determines how much emphasis should be placed on parts of input information when interpreting other parts of the input information. Consider, for example, a sentence that reads: “I asked the professor a question, but he could not answer it.” When interpreting the word “it,” the attention component 1706 will determine how much weight or emphasis should be placed on each of the words of the sentence. The attention component 1706 will find that the word “question” is most significant. In some examples, the attention component 1706 performs attention analysis using the following equation:

$$Attention ( Q , K , V ) = softmax ( \frac{Q {K}^{T}}{\sqrt{{d}_{k}}} ) V . \qquad ( 1 )$$

The attention component 1706 produces query information Q by multiplying the embeddings associated with the input information 1618 by a query weighting matrix W^{Q}. Similarly, the attention component 1706 produces key information K and value information V by multiplying the embeddings provided by input information 1618 by a key weighting matrix W^{K} and a value weighting matrix W^{V}, respectively. To execute Equation (1), the attention component 1706 takes the dot product of Q with the transpose of K, and then divides the dot product by a scaling factor \sqrt{d}, to produce a scaled result. The symbol d represents the dimensionality of Q and K. The attention component 1706 takes the Softmax (normalized exponential function) of the scaled result, and then multiplies the result of the Softmax operation by V, to produce attention output information. In some cases, the attention component 1706 is said to perform masked attention insofar as the attention component 1706 masks output token information that, at any given time, has not yet been determined. Background information regarding the general concept of attention is provided in Vaswani, et al., “Attention Is All You Need,” in 31st Conference on Neural Information Processing Systems (NIPS 2017), 2017, 14 pages.

Note that FIG. 17 shows that the attention component 1706 is composed of plural attention heads, including a representative attention head 1714. Each attention head performs the computations specified by Equation (1), but with respect to a particular representational subspace that is different than the subspaces of the other attention heads. To accomplish this operation, the attention heads perform the computations described above using different respective sets of query, key, and value weight matrices. Although not shown, the attention component 1706 concatenates the output results of the attention component's separate attention heads, and then multiplies the results of this concatenation by another weight matrix W^{O}.

The add-and-normalize component 1708 includes a residual connection that combines (e.g., sums) input information fed to the attention component 1706 with the output information generated by the attention component 1706. The add-and-normalize component 1708 then normalizes the output information generated by the residual connection, e.g., by layer-normalizing values in the output information based on the mean and standard deviation of those values, or by performing root-mean-squared normalization. The other add-and-normalize component 1712 performs the same functions as the first-mentioned add-and-normalize component 1708. The FFN component 1710 transforms input information to output information using a feed-forward neural network having any number of layers.

The first transformer component 1704 produces output information 1716. A series of other transformer components (1718, . . . , 1720) perform the same functions as the first transformer component 1704, each operating on output information produced by its immediately preceding transformer component. Each transformer component uses its own level-specific set of machine-trained weights. The final transformer component 1720 in the language model 1702 produces final output information 1722.

In some implementations, a post-processing component 1724 performs post-processing operations on the final output information 1722. For example, the post-processing component 1724 performs a machine-trained linear transformation on the final output information 1722, and processes the results of this transformation using a Softmax component (not shown). The language model 1702 uses the output of the post-processing component 1724 to predict the next token in the input sequence of tokens. In some applications, the language model 1702 performs this task using a greedy selection approach (e.g., by selecting the token having the highest probability), or by using the beam search algorithm (e.g., by traversing a tree that expresses a search space of candidate next tokens).

In some implementations, the language model 1702 operates in an auto-regressive manner, as indicated by the loop 1726. To operate in this way, the language model 1702 appends a predicted token to the end of the sequence of input tokens, to provide an updated sequence of tokens. The predicted token leads to the production of a new embedding 1728. In a next pass, the language model 1702 processes the updated sequence of position-supplemented vectors to generate a next predicted token. The language model 1702 repeats the above process until it generates a specified stop token.

The above-described implementation of the language model 1702 relies on a decoder-only architecture. Other implementations of the language model 1702 use an encoder-decoder transformer-based architecture. Here, a transformer-based decoder receives encoder output information produced by a transformer-based encoder, together with decoder input information. The encoder output information specifically includes KV information that serves an input to the attention components of the decoder (except the first transformer component). Other implementations of the language model 1702 use other kinds of machine-trained models besides, or in addition to, the particular transformer-based architecture shown in FIG. 17. The other machine-trained models include any of convolutional neural networks (CNNs), recurrent neural networks (RNNs), fully-connected feed-forward neural networks (FFNS), stable diffusion models, etc., or any combination thereof.

### G. Illustrative Processes

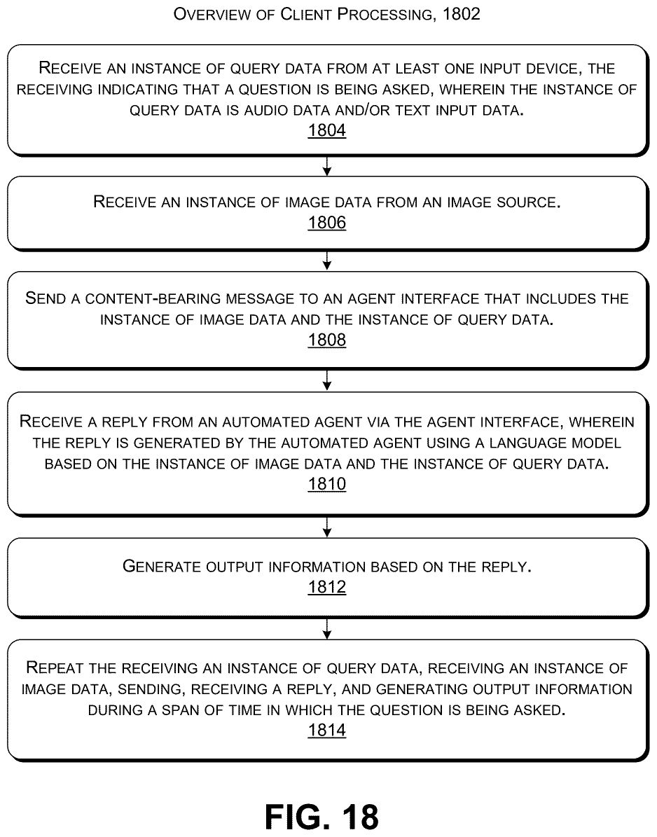

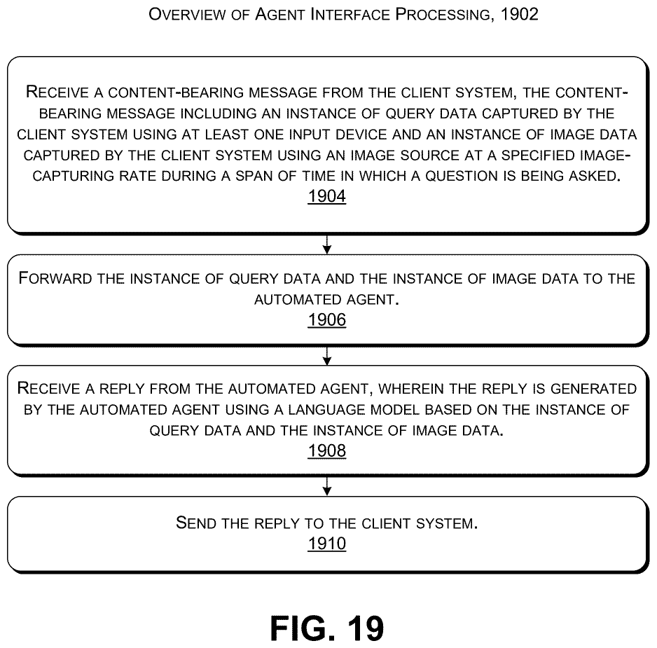

FIGS. 18 and 19 show two processes that represent an overview of the operation of the multi-modal agent system 502 of FIG. 5. Each of the processes is expressed as a series of operations performed in a particular order. But the order of these operations is merely representative, and the operations are capable of being varied in other implementations. Further, any two or more operations described below are capable of being performed in a parallel manner. In one implementation, the blocks shown in the processes that pertain to processing-related functions are implemented by the computing equipment described in connection with FIG. 20.

More specifically, FIG. 18 shows a process 1802 performed by the client system 504 for interacting with the automated agent 508. In block 1804, the client system 504 receives an instance of query data from at least one input device, the receiving indicating that a question is being asked, wherein the instance of query data is audio data and/or text input data. In block 1806, the client system 504 receives an instance of image data from an image source. In block 1808, the client system 504 sends a content-bearing message to an agent interface 506 that includes the instance of image data and the instance of query data. In block 1810, the client system 504 receives a reply from the automated agent 508 via the agent interface 506, wherein the reply is generated by the automated agent 508 using a language model 510 based on the instance of image data and the instance of query data. In block 1812, the client system 504 generates output information based on the reply. In block 1814, the client system 504 repeats the receiving an instance of query data, receiving an instance of image data, sending, receiving a reply, and generating output information during a span of time in which the question is being asked.

FIG. 19 shows a process 1902 performed by the agent interface 506 for conducting a multi-modal interaction between the client system 504 and an automated agent 508. In block 1904, the agent interface 506 receives a content-bearing message from the client system 504. The content-bearing message includes an instance of query data captured by the client system 504 using at least one input device and an instance of image data captured by the client system 504 using an image source at a specified image-capturing rate during a span of time in which a question is being asked. In block 1906, the agent interface 506 forwards the instance of query data and the instance of image data to the automated agent 508. In block 1908, the agent interface 506 receives a reply from the automated agent 508, wherein the reply is generated by the automated agent using a language model 510 based on the instance of query data and the instance of image data. In block 1910, the agent interface 506 sends the reply to the client system 504.

### H. Illustrative Computing System Hardware

FIG. 20 shows a computing system 2002 that, in some implementations, is used to implement any aspect of the mechanisms set forth in the above-described figures. For instance, in some implementations, the type of computing system 2002 shown in FIG. 20 is used to implement any local computing device or any server in the multi-modal agent system 502 of FIG. 5. In all cases, the computing system 2002 represents a physical and tangible processing mechanism.

The computing system 2002 includes a processing system 2004 including one or more processors. The processor(s) include one or more central processing units (CPUs), and/or one or more graphics processing units (GPUs), and/or one or more application specific integrated circuits (ASICs), and/or one or more neural processing units (NPUs), and/or one or more tensor processing units (TPUs), etc. More generally, any processor corresponds to a general-purpose processing unit or an application-specific processor unit.

The computing system 2002 also includes computer-readable storage media 2006, corresponding to one or more computer-readable media hardware units. The computer-readable storage media 2006 retains any kind of information 2008, such as machine-readable instructions, settings, model weights, and/or other data. In some implementations, the computer-readable storage media 2006 includes one or more solid-state devices, one or more hard disks, one or more optical disks, etc. Any instance of the computer-readable storage media 2006 represents a fixed or removable unit of the computing system 2002. Further, any instance of the computer-readable storage media 2006 provides volatile and/or non-volatile retention of information. The specific term “computer-readable storage medium” or “storage device” expressly excludes propagated signals per se in transit; a computer-readable storage medium or storage device is “non-transitory” in this regard.

The computing system 2002 utilizes any instance of the computer-readable storage media 2006 in different ways. For example, in some implementations, any instance of the computer-readable storage media 2006 represents a hardware memory unit (such as random access memory (RAM)) for storing information during execution of a program by the computing system 2002, and/or a hardware storage unit (such as a hard disk) for retaining/archiving information on a more permanent basis. In the latter case, the computing system 2002 also includes one or more drive mechanisms 2010 (such as a hard drive mechanism) for storing and retrieving information from an instance of the computer-readable storage media 2006.

In some implementations, the computing system 2002 performs any of the functions described above when the processing system 2004 executes computer-readable instructions stored in any instance of the computer-readable storage media 2006. For instance, in some implementations, the computing system 2002 carries out computer-readable instructions to perform each block of the processes described with reference to FIGS. 18 and 19. FIG. 20 generally indicates that hardware logic circuitry 2012 includes any combination of the processing system 2004 and the computer-readable storage media 2006.

In addition, or alternatively, the processing system 2004 includes one or more other configurable logic units that perform operations using a collection of logic gates, such as field-programmable gate arrays (FPGAs), etc. In these implementations, the processing system 2004 effectively incorporates a storage device that stores computer-readable instructions, insofar as the configurable logic units are configured to execute the instructions and therefore embody or store these instructions.

In some cases (e.g., in the case in which the computing system 2002 represents a user computing device), the computing system 2002 also includes an input/output interface 2014 for receiving various inputs (via input devices 2016), and for providing various outputs (via output devices 2018). Illustrative input devices include a keyboard device, a mouse input device, a touchscreen input device, a digitizing pad, one or more static image cameras, one or more video cameras, one or more depth camera systems, one or more microphones, a voice recognition mechanism, any position-determining devices (e.g., GPS devices), any movement detection mechanisms (e.g., accelerometers and/or gyroscopes), etc. In some implementations, one particular output mechanism includes a display device 2020 and an associated graphical user interface presentation (GUI) 2022. The display device 2020 corresponds to a liquid crystal display device, a light-emitting diode display (LED) device, a cathode ray tube device, a projection mechanism, etc. Other output devices include a printer, one or more speakers, a haptic output mechanism, an archival mechanism (for storing output information), etc. In some implementations, the computing system 2002 also includes one or more network interfaces 2024 for exchanging data with other devices via one or more communication conduits 2026. One or more communication buses 2028 communicatively couple the above-described units together.

The communication conduit(s) 2026 is implemented in any manner, e.g., by a local area computer network, a wide area computer network (e.g., the Internet), point-to-point connections, or any combination thereof. The communication conduit(s) 2026 include any combination of hardwired links, wireless links, routers, gateway functionality, name servers, etc., governed by any protocol or combination of protocols.

FIG. 20 shows the computing system 2002 as being composed of a discrete collection of separate units. In some cases, the collection of units corresponds to discrete hardware units provided in a computing device chassis having any form factor. FIG. 20 shows illustrative form factors in its bottom portion. In other cases, the computing system 2002 includes a hardware logic unit that integrates the functions of two or more of the units shown in FIG. 20. For instance, in some implementations, the computing system 2002 includes a system on a chip (SoC or SOC), corresponding to an integrated circuit that combines the functions of two or more of the units shown in FIG. 20.

The following summary provides a set of illustrative examples of the technology set forth herein.

(A1) According to one aspect, a method (e.g., the process 1802) is described, performed by a client system (e.g., the client system 504), for interacting with an automated agent (e.g., the automated agent 508). The method includes: receiving (e.g., in block 1804) an instance of query data from at least one input device, the receiving indicating that a question is being asked, wherein the instance of query data is audio data and/or text input data; receiving (e.g., in block 1806) an instance of image data from an image source; sending (e.g., in block 1808) a content-bearing message to an agent interface (e.g., the agent interface 506) that includes the instance of image data and the instance of query data; receiving (e.g., in block 1810) a reply from the automated agent via the agent interface, wherein the reply is generated by the automated agent using a language model (e.g., the language model 510) based on the instance of image data and the instance of query data; generating (e.g., in block 1812) output information based on the reply; and repeating (e.g., in block 1814) the receiving an instance of query data, receiving an instance of image data, receiving a reply, and generating output information during a span of time in which the question is being asked.

(A2) According to illustrative aspects of the method of A1, the method further includes: receiving a specified image-capturing rate from the agent interface; and capturing instances of image data at the specified image-capturing rate over the span of time in which the question is being asked.

(A3) According to illustrative aspects of the method of A1 or A2, the method further includes: generating a rate-of-change measure based on an extent to which image content changes over successive instances of image data that has been captured; setting a specified image-capturing rate based on the rate-of-change measure, wherein the image-capturing rate determines a rate at which instances of image data are captured; and repeating the generating and setting over the span of time in which the question is being asked.

(A4) According to illustrative aspects of any of the methods of A1-A3, the instance of image data is an instance of original image data, wherein the method further includes reducing resolution of original image data to produce an instance of resolution-reduced image data, and wherein the instance of image data that is provided to agent interface is the instance of resolution-reduced image data.

(A5) According to illustrative aspects of the method of A4, the reducing includes: reducing resolution of the instance of original image to a target width and a target height, the target width having a predetermined width value, and the target height being a function of the predetermined width value and an aspect ratio of a display device of the client system.

(A6) According to illustrative aspects of any of the methods of A1-A5, the image source is a camera, wherein the camera is instructed to capture instances of camera image data at a prescribed image-capturing rate during the span of time in which the question is being asked.

(A7) According to illustrative aspects of any of the methods of A1-A6, the image source is a user interface (UI) system that generates screen image data to be displayed by the client system, wherein the client system captures instances of screen image data from the UI system at a prescribed image-capturing rate during the span of time in which the question is being asked.

(A8) According to illustrative aspects of the method of A7, for a particular sampling time given by the image-capturing rate, determining that a current instance of screen image data is same as an immediately preceding instance of screen image data; and suspending an operation of sending the current instance of screen image data to the agent interface.

(A9) According to illustrative aspects of the method of A7 or A8, the method further includes: identifying a portion of a current instance of screen image data that differs from an immediately preceding instance of screen image data, wherein the instance of image data that is provided to the agent interface is the portion, and wherein the portion is less than an entirety of the current instance of screen image data.

(A10) According to illustrative aspects of the method of A9, the portion of the current instance screen image data is expressed as an area of screen content that is not shared by the immediately preceding instance screen image data, and wherein the portion that is sent to the agent interface is accompanied by position information that describes a position of the area in the entirety of the current instance of screen data.

(A11) According to illustrative aspects of the methods of A9 or A10, the current instance of screen image data and the immediately preceding instance of screen image data are presented on the display device at two respective instances of time during a scrolling operation.

(A12) According to illustrative aspects of any of the methods of A7-A11, the method further includes: receiving another instance of screen image data from the UI system; determining that the aforementioned another instance of screen image data contains textual information; converting the aforementioned another instance of screen image data into text; and providing the text to the agent interface in lieu of the aforementioned another instance of screen image data.

(A13) According to illustrative aspects of any of the methods of A7-A12, the screen image data presented on the display device includes plural portions that originate from plural respective sources, and wherein the instance of image data that is provided to the agent interface is selected from among the plural portions based on at least one selection factor.

(B1) According to another illustrative aspect, a method (e.g., the process 1902) is described by which an agent interface (e.g., the agent interface 506) performs a multi-modal interaction between a client system (e.g., the client system 504) and an automated agent (e.g., the automated agent 508). The method includes: receiving (e.g., in block 1904) a content-bearing message from the client system, the content-bearing message including an instance of query data captured by the client system using at least one input device and an instance of image data captured by the client system using an image source at a specified image-capturing rate during a span of time in which a question is being asked; forwarding (e.g., in block 1906) the instance of query data and the instance of image data to the automated agent; receiving (e.g., in block 1908) a reply from the automated agent, wherein the reply is generated by the automated agent using a language model (e.g., the language model 510) based on the instance of query data and the instance of image data; and sending (e.g., in block 1910) the reply to the client system.

(B2) According to an illustrative aspects of the method of B1, in a static prompt insertion mode, the method further includes: receiving an indication from the client system that an application has been started that will include capture of instances of image data; and in response to the indication, adding an instruction to a system prompt that directs the language model to process the instances of image data in a prescribed manner.

(B3) According to illustrative aspects of the methods of B1, in a dynamic insertion mode, the method further includes: receiving an indication from the client system that the question has started; adding an instruction to a system prompt that directs the language model to process instances of image data in a prescribed manner, to provide an updated system prompt; and forwarding the updated system prompt to the automated agent.

(B4) According to illustrative aspects of the method of B3, the method further includes: receiving an indication from the client system that the question has ended; removing the instruction from the system prompt, to provide a further-updated system prompt; and forwarding the further-updated system prompt to the automated agent.

In yet another aspect, some implementations of the technology described herein include a computing system (e.g., the computing system 2002) that includes a processing system (e.g., the processing system 2004) having a processor. The computing system also includes a storage device (e.g., the computer-readable storage media 2006) for storing computer-readable instructions (e.g., the information 2008). The processing system executes the computer-readable instructions to perform any of the methods described herein (e.g., any individual method of the methods of A1-A13 or B1-B4).

In yet another aspect, some implementations of the technology described herein include a computer-readable storage medium (e.g., the computer-readable storage media 2006) for storing computer-readable instructions (e.g., the information 2008). A processing system (e.g., the processing system 2004) executes the computer-readable instructions to perform any of the operations described herein (e.g., the operations in any individual method of the methods of A1-A13 or B1-B4).

More generally stated, any of the individual elements and steps described herein are combinable into any logically consistent permutation or subset. Further, any such combination is capable of being manifested as a method, device, system, computer-readable storage medium, data structure, article of manufacture, graphical user interface presentation, etc. The technology is also expressible as a series of means-plus-format elements in the claims, although this format should not be considered to be invoked unless the phrase “means for” is explicitly used in the claims.

This description may have identified one or more features as optional. This type of statement is not to be interpreted as an exhaustive indication of features that are to be considered optional; generally, any feature is to be considered as an example, although not explicitly identified in the text, unless otherwise noted. Further, any features described as alternative ways of carrying out identified functions or implementing identified mechanisms are also combinable together in any combination, unless otherwise noted.

In terms of specific terminology, the phrase “configured to” encompasses various physical and tangible mechanisms for performing an identified operation. The mechanisms are configurable to perform an operation using the hardware logic circuitry 2012 of FIG. 20. The term “logic” likewise encompasses various physical and tangible mechanisms for performing a task. For instance, each processing-related operation illustrated in the flowcharts of FIGS. 18 and 19 corresponds to a logic component for performing that operation.

Further, the term “plurality” or “plural” or the plural form of any term (without explicit use of “plurality” or “plural”) refers to two or more items, and does not necessarily imply “all” items of a particular kind, unless otherwise explicitly specified. The term “at least one of” refers to one or more items; reference to a single item, without explicit recitation of “at least one of” or the like, is not intended to preclude the inclusion of plural items, unless otherwise noted. Further, the descriptors “first,” “second,” “third,” etc. are used to distinguish among different items, and do not imply an ordering among items, unless otherwise noted. The phrase “A and/or B” means A, or B, or A and B. The phrase “any combination thereof” refers to any combination of two or more elements in a list of elements. Further, the terms “comprising,” “including,” and “having” are open-ended terms that are used to identify at least one part of a larger whole, but not necessarily all parts of the whole. A “set” is a group that includes one or more members. The phrase “A corresponds to B” means “A is B” in some contexts. The term “prescribed” is used to designate that something is purposely chosen according to any environment-specific considerations. For instance, a threshold value or state is said to be prescribed insofar as it is purposely chosen to achieve a desired result. “Environment-specific” means that a state is chosen for use in a particular environment. Finally, the terms “exemplary” or “illustrative” refer to one implementation among potentially many implementations.

In closing, the functionality described herein is capable of employing various mechanisms to ensure that any user data is handled in a manner that conforms to applicable laws, social norms, and the expectations and preferences of individual users. For example, the functionality is configurable to allow a user to expressly opt in to (and then expressly opt out of) the provisions of the functionality. The functionality is also configurable to provide suitable security mechanisms to ensure the privacy of the user data (such as data-sanitizing mechanisms, encryption mechanisms, and/or password-protection mechanisms).

Further, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, performed by a client system, for interacting with an automated agent, comprising:
receiving an instance of query data from at least one input device, the receiving indicating that a question is being asked, wherein the instance of query data is audio data and/or text input data;
receiving an instance of image data from an image source;
sending a content-bearing message to an agent interface that includes the instance of image data and the instance of query data;
receiving a reply from the automated agent via the agent interface, wherein the reply is generated by the automated agent using a language model based on the instance of image data and the instance of query data;
generating output information based on the reply; and
repeating the receiving an instance of query data, receiving an instance of image data, sending, receiving a reply, and generating output information during a span of time in which the question is being asked.

2. The method of claim 1, wherein the method further comprises:
receiving a specified image-capturing rate from the agent interface; and
capturing instances of image data at the specified image-capturing rate over the span of time in which the question is being asked.

3. The method of claim 1, wherein the method further comprises:
generating a rate-of-change measure based on an extent to which image content changes over successive instances of image data that has been captured;
setting a specified image-capturing rate based on the rate-of-change measure, wherein the image-capturing rate determines a rate at which instances of image data are captured; and
repeating the generating and setting over the span of time in which the question is being asked.

4. The method of claim 1, wherein the instance of image data is an instance of original image data, wherein the method further comprises reducing resolution of original image data to produce an instance of resolution-reduced image data, and wherein the instance of image data that is provided to agent interface is the instance of resolution-reduced image data.

5. The method of claim 4, wherein the reducing comprises:
reducing resolution of the instance of original image to a target width and a target height,
the target width having a predetermined width value, and the target height being a function of the predetermined width value and an aspect ratio of a display device of the client system.

6. The method of claim 1, wherein the image source is a camera, wherein the camera is instructed to capture instances of camera image data at a prescribed image-capturing rate during the span of time in which the question is being asked.

7. The method of claim 1, wherein the image source is a user interface (UI) system that generates screen image data to be displayed by the client system, wherein the client system captures instances of screen image data from the UI system at a prescribed image-capturing rate during the span of time in which the question is being asked.

8. The method of claim 7,
for a particular sampling time given by the image-capturing rate, determining that a current instance of screen image data is same as an immediately preceding instance of screen image data; and
suspending an operation of sending the current instance of screen image data to the agent interface.

9. The method of claim 7, wherein the method further comprises:
identifying a portion of a current instance of screen image data that differs from an immediately preceding instance of screen image data,
wherein the instance of image data that is provided to the agent interface is the portion, and wherein the portion is less than an entirety of the current instance of screen image data.

10. The method of claim 9, wherein the portion of the current instance screen image data is expressed as an area of screen content that is not shared by the immediately preceding instance screen image data, and wherein the portion that is sent to the agent interface is accompanied by position information that describes a position of the area in the entirety of the current instance of screen data.

11. The method of claim 9, wherein the current instance of screen image data and the immediately preceding instance of screen image data are presented on the display device at two respective instances of time during a scrolling operation.

12. The method of claim 7, further comprising:
receiving another instance of screen image data from the UI system;
determining that said another instance of screen image data contains textual information;
converting said another instance of screen image data into text; and
providing the text to the agent interface in lieu of said another instance of screen image data.

13. The method of claim 7,
wherein the screen image data presented on the display device includes plural portions that originate from plural respective sources, and
wherein the instance of image data that is provided to the agent interface is selected from among the plural portions based on at least one selection factor.

14. A computing system for performing a multi-modal interaction between a client system and an automated agent, comprising:
an instruction data store for storing computer-readable instructions; and
a processing system for executing the computer-readable instructions in the data store, to perform operations including:
receiving a content-bearing message from the client system, the content-bearing message including an instance of query data captured by the client system using at least one input device and an instance of image data captured by the client system using an image source at a specified image-capturing rate during a span of time in which a question is being asked;
forwarding the instance of query data and the instance of image data to the automated agent;
receiving a reply from the automated agent, wherein the reply is generated by the automated agent using a language model based on the instance of query data and the instance of image data; and
sending the reply to the client system.

15. The computing system of claim 14, wherein the image source is a camera and/or a user interface (UI) system that generates instances of screen image data to be displayed by the client system.

16. The computing system of claim 14, wherein the operation further comprise, in a static prompt insertion mode:
receiving an indication from the client system that an application has been started that will include capture of instances of image data; and
in response to the indication, adding an instruction to a system prompt that directs the language model to process the instances of image data in a prescribed manner.

17. The computing system of claim 14, wherein the operations further comprise, in a dynamic insertion mode:
receiving an indication from the client system that the question has started;
adding an instruction to a system prompt that directs the language model to process instances of image data in a prescribed manner, to provide an updated system prompt; and
forwarding the updated system prompt to the automated agent.

18. The computing system of claim 17, wherein the operations further comprise:
receiving an indication from the client system that the question has ended;
removing the instruction from the system prompt, to provide a further-updated system prompt; and
forwarding the further-updated system prompt to the automated agent.

19. A computer-readable storage medium for storing computer-readable instructions, a processing system executing the computer-readable instructions to perform operations, the operations of:
receiving an indication from a client system that a question has started;
adding an instruction to a system prompt that directs a language model to process instance of image data in a prescribed manner, to provide an updated system prompt;
forwarding the updated system prompt to the language model;
receiving one or more content-bearing messages from the client system, each content-bearing message including an instance of audio data and an instance of image data, wherein the client system captures instances of image data from an image source at a prescribed image-capturing rate while the question is being asked;
forwarding the one or more instances of query data and image data that are received from the client system to the language model;
receiving one or more replies from the language model based on the one or more instances of query data and image data;
sending the one or more replies to the client system;
receiving an indication from the client system that the question has ended;
removing the instruction from the system prompt, to provide a further-updated system prompt; and
forwarding the further-updated system prompt to the language model.

20. The computer-readable storage medium of claim 19, wherein the image source is a camera and/or user interface (UI) system that generates instances of screen image data to be displayed by the client system.
